(19) United States
(12) Patent Application Publication
(10) Pub. No.: US 2026/0175181 A1
(43) Pub. Date: Jun. 25, 2026

(54) GAS CAPTURE SURFACES FOR ENHANCED ABSORPTION AND/OR REACTION AND RELATED SYSTEMS AND METHODS

(71) Applicant: Massachusetts Institute of Technology, Cambridge, MA (US)

(72) Inventors: Kripa K. Varanasi, Lexington, MA (US); Jack R. Lake, Cambridge, MA (US); Victor Julio Leon, Cambridge, MA (US); Tal Joseph, Cambridge, MA (US); Sami Khan, Cambridge, MA (US)

(73) Assignee: Massachusetts Institute of Technology, Cambridge, MA (US)

(21) Appl. No.: 19/123,931

(22) PCT Filed: Oct. 27, 2023
(86) PCT No.: PCT/US2023/078101

§ 371 Date: Apr. 24, 2025

Related U.S. Application Data
(60) Provisional application No. 63/381,285, filed on Oct. 27, 2022.

(51) Int. Cl. B01F 23/237; B01D 53/18; B01F 23/231; B01F 23/232; B01F 23/2373

(52) U.S. Cl. CPC B01F 23/237612; B01D 53/18; B01D 53/185; B01F 23/23123; B01F 23/231265; B01F 23/2323; B01F 23/2373

(57) ABSTRACT

Dissolution of a gas in a liquid medium and/or reaction of a gas with one or more components within a liquid medium using a variety of articles, systems, and methods is generally described.

### RELATED APPLICATIONS

This application claims priority under 35 U.S.C. § 119 (e) to U.S. Provisional Patent Application No. 63/381,285, filed Oct. 27, 2022, and entitled “Direct Injection of Gas into Engineered Capture Surfaces for Enhanced Absorption,” which is incorporated herein by reference in its entirety for all purposes.

### TECHNICAL FIELD

Articles, systems, and methods for dissolving a gas in a liquid medium and/or reacting a gas with one or more components within a liquid medium are generally described.

### SUMMARY

Dissolution of a gas in a liquid medium and/or reaction of a gas with one or more components within a liquid medium using a variety of articles, systems, and methods is generally described. The subject matter of the present invention involves, in some cases, interrelated products, alternative solutions to a particular problem, and/or a plurality of different uses of one or more systems and/or articles.

This Summary introduces a selection of concepts in simplified form that are described further below in the Detailed Description. This Summary neither identifies key or essential features, nor limits the scope, of the claimed subject matter. Some aspects are related to systems. In some embodiments, a system comprises a liquid medium, a source of gas within and/or in fluidic communication with the liquid medium, and a nanoengineered surface in contact with the liquid medium, wherein the system is configured such that injected gas from the source of gas spreads on the nanoengineered surface such that the spread gas dissolves in the liquid medium and/or reacts with one or more components of the liquid medium. In some such embodiments, the nanoengineered surface is associated with a plastron layer, and the system is configured such that the injected gas from the source of gas spreads through the plastron layer such that the spread gas dissolves in the liquid medium and/or reacts with one or more components of the liquid medium.

In some embodiments, a system comprises a liquid medium, a source of bubbles within and/or in fluidic communication with the liquid medium, and a nanoengineered surface in contact with the liquid medium, wherein the system is configured such that bubbles from the source of bubbles are captured by and spread on the nanoengineered surface such that the spread bubbles dissolve in the liquid medium and/or react with one or more components of the liquid medium.

Certain aspects are related to methods. In some embodiments, a method comprises contacting a nanoengineered surface with a liquid medium, and injecting a gas at or near the nanoengineered surface, wherein the injected gas spreads on the nanoengineered surface, and wherein the spread gas dissolves in the liquid medium and/or reacts with one or more components within the liquid medium. In some such embodiments, the nanoengineered surface is associated with a plastron layer, the injecting comprises injecting the gas at or near the plastron layer, and the injected gas from the source of gas spreads through the plastron layer such that the spread gas dissolves in the liquid medium and/or reacts with one or more components of the liquid medium.

In some embodiments, a method comprises contacting a nanoengineered surface with a liquid medium, and injecting a gas at or near the nanoengineered surface, wherein the injected gas forms bubbles, wherein the bubbles are captured by and spread on the nanoengineered surface, and wherein the spread bubbles dissolve in the liquid medium and/or react with one or more components within the liquid medium.

One aspect of the disclosure herein is a method for absorbing a gas into a liquid medium, the method comprising
a. providing a nanoengineered surface;
b. contacting the nanoengineered surface with the liquid medium;
c. injecting the gas at or near the nanoengineered surface,
wherein the injected gas forms bubbles, wherein the bubbles are captured and spread on the nanoengineered surface, and wherein the spread bubbles dissolve in the liquid medium.

In one embodiment of the disclosed method, the liquid medium comprises an aqueous solution. In one embodiment the nanoengineered surface is hydrophobic.

In one embodiment of the disclosed method, the nanoengineered surface possess a nanoscale texture.

In one embodiment of the disclosed method, the nanoengineered surface comprises polytetrafluoroethylene.

In one embodiment of the disclosed method, the nanoengineered surface is silanized.

In one embodiment of the disclosed method, the gas comprises carbon dioxide (CO₂).

In one embodiment of the disclosed method, the liquid medium comprises aqueous NaOH or KOH.

In one embodiment of the disclosed method, the gas is injected through a needle or a multiplicity of needles.

In one embodiment of the disclosed method, the gas is delivered through perforations in the nanoengineered surface.

The following Detailed Description references the accompanying drawings which form a part this application, and which show, by way of illustration, specific example implementations. Other implementations may be made without departing from the scope of the disclosure. Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, in accordance with certain embodiments, a cross-sectional schematic diagram representing a method comprising contacting a nanoengineered surface with a liquid medium.

FIG. 1B is, in accordance with certain embodiments, a cross-sectional schematic diagram representing a method comprising injecting a gas at or near a nanoengineered surface.

FIG. 1C-1E are, in accordance with certain embodiments, cross-sectional schematic diagrams representing a method wherein a bubble is captured by and spread on a nanoengineered surface.

FIG. 1F is, in accordance with certain embodiments, a cross-sectional schematic diagram representing a method wherein a spread bubble dissolves in a liquid medium and/or reacts with one or more components within the liquid medium.

FIG. 1G is, in accordance with certain embodiments, a cross-sectional schematic diagram representing a method wherein a second bubble is captured by a nanoengineered surface.

FIG. 2 is, in accordance with certain embodiments, a cross-sectional schematic diagram illustrating the interaction of a bubble with a nanoengineered surface.

FIG. 3A is, in accordance with certain embodiments, a cross-sectional schematic diagram representing a method comprising contacting a nanoengineered surface with a liquid medium, wherein the nanoengineered surface is associated with a plastron layer.

FIG. 3B is, in accordance with certain embodiments, a cross-sectional schematic diagram representing a method comprising injecting a gas at or near a nanoengineered surface associated with a plastron layer.

FIG. 3C-3E are in accordance with certain embodiments, cross-sectional schematic diagrams representing a method wherein injected gas is spread on a nanoengineered surface such that the injected gas spreads through a plastron layer.

FIG. 3F is, in accordance with certain embodiments, a cross-sectional schematic diagram representing a method wherein spread gas dissolves in a liquid medium and/or reacts with one or more components within the liquid medium.

FIG. 3G is, in accordance with certain embodiments, a cross-sectional schematic diagram representing a method wherein a second gas is injected at or near a nanoengineered surface associated with a plastron layer.

FIG. 4 is, in accordance with certain embodiments, a cross-sectional schematic diagram illustrating the interaction of a gas with a nanoengineered surface associated with a plastron layer.

FIG. 5A is, in accordance with certain embodiments, a cross-sectional schematic diagram of a nanoengineered surface.

FIG. 5B is, in accordance wither certain embodiments, a perspective view schematic diagram of the nanoengineered surface shown in FIG. 5A.

FIG. 5C is, in accordance with certain embodiments, a top view schematic diagram of the nanoengineered surface shown in FIGS. 5A-5B.

FIG. 6A is, in accordance certain embodiments, a cross-sectional schematic diagram of a nanoengineered surface comprising one or more perforations.

FIG. 6B is, in accordance with certain embodiments, a top view schematic diagram of a nanoengineered surface shown in FIG. 6A.

FIG. 7A is, in accordance with certain embodiments, a cross-sectional schematic diagram representing a method comprising injecting a gas through one or more perforations in a nanoengineered surface.

FIG. 7B is, in accordance with certain embodiments, a cross-sectional schematic diagram representing a method comprising injecting a gas through one or more perforations in a nanoengineered surface, wherein the nanoengineered surface is associated with a plastron layer.

FIG. 8A is, in accordance with certain embodiments, a cross-sectional schematic diagram representing a method comprising contacting a nanoengineered surface with a liquid medium, wherein the nanoengineered surface is partially submerged in the liquid medium.

FIG. 8B is, in accordance with certain embodiments, a cross-sectional schematic diagram representing a method comprising contacting a nanoengineered surface associated with a plastron layer with a liquid medium, wherein the nanoengineered surface is partially submerged in the liquid medium.

FIG. 9A is, in accordance with certain embodiments, a cross-sectional schematic diagram representing a method comprising injecting a gas at or near a nanoengineered surface, wherein the gas is injected through a multiplicity of sources of gas.

FIG. 9B is, in accordance with certain embodiments, a cross-sectional schematic diagram representing a method comprising injecting a gas at or near a nanoengineered surface associated with a plastron layer, wherein the gas is injected through a multiplicity of sources of gas.

FIG. 10A is, in accordance with certain embodiments, an exemplary cross-sectional schematic diagram illustrating the interaction of a liquid droplet with a surface when the surface is non-wetting with respect to the liquid.

FIG. 10B is, in accordance with certain embodiments, an exemplary cross-sectional schematic diagram illustrating the interaction of a liquid droplet with a surface when the surface is wetting with respect to the liquid.

FIG. 11 is, in accordance with certain embodiments, a cross-sectional schematic diagram illustrating the interaction of a gas with trapped gas positioned between features on a nanoengineered surface.

FIG. 12A is, in accordance with certain embodiments, a schematic diagram representing an experimental setup used to collect side-profile images of captured CO₂ bubbles during absorption over time in 0.1 M KOH absorbate.

FIG. 12B shows, in accordance with certain embodiments, an illustrative image collected during data acquisition (left) followed by binarization of the bubble image (center and right), which allows for rotating this 2D image around its approximate axis of symmetry to calculate the volume of the captured bubble as a function of time.

FIG. 12C is, in accordance with certain embodiments, a plot showing the evolution of bubble volume due to absorption over time for two different sized captured CO₂ bubbles delivered to a surface using two differently sized dispensing needles. Solid lines represent directly measured results and dotted lines represent predictions of the absorption of the bubble using a developed analytical model.

FIG. 12D is, in accordance with certain embodiments, a plot showing the average initial reaction rate observed over the first 20 seconds for various bubble sizes tested, along with the corresponding predicted average reaction rate for this same period as predicted by the model.

FIG. 12E is, in accordance with certain embodiments, a graphical illustration of two phenomena occurring as time is elapsed for a captured bubble during experiments. First, the mass diffusion boundary evolves to grow over time as it is developed, denoted by 8. Second, reacted particles that are formed at the interface accumulate over time until they cause the bubble absorption to effectively plateau and stop the reaction from continuing.

FIG. 13A shows, in accordance with certain embodiments, time lapse images of a CO₂ bubble deposited onto a smooth hydrophobic polytetrafluoroethylene (PTFE, also known as Teflon®) surface to enhance its surface area relative to its volume.

FIG. 13B is, in accordance with certain embodiments, a plot showing the evolution of bubble volume due to absorption over time for two bubbles of equivalent volume placed on either a smooth silicon hydrophilic surface or a smooth PTFE hydrophilic surface, showing that effectively the same absorption dynamics are observed for the first approximately 25 seconds, and the plateauing behavior persists in both cases.

FIG. 13C is, in accordance with certain embodiments, a plot showing the average initial reaction rate observed over the first 20 seconds for various bubble sizes tested for both a smooth hydrophilic silicon surface and a smooth hydrophobic PTFE surface.

FIG. 14A shows, in accordance with certain embodiments, contact angle measurements for various capture surfaces tested using a droplet of water to measure the wetting properties relevant for a potassium hydroxide (KOH) solution (top) and scanning electron microscopy (SEM) micrographs of the three textured capture surfaces tested, a b5 micropost surface, a low-phi laser ablated surface, and a reactive ion etched “nanograss” nanotextured surface (bottom).

FIG. 14B is, in accordance with certain embodiments, a plot showing the contact line motion over time for an air bubble brought to the surface of the tested capture surfaces while surrounding in non-reacting deionized water, showing how the nanotexture achieves rapid and full spreading, along with the fact that a trapped gas layer is not required for the enhanced bubble capture to occur.

FIG. 14C shows, in accordance with certain embodiments, time lapses of high-speed imaging photographs showing the evolution of the contact line for the b5 micropost surface.

FIG. 14D shows, in accordance with certain embodiments, time lapses of high-speed imaging photographs showing the evolution of the contact line for the nanograss surface.

FIG. 14E shows, in accordance with certain embodiments, time lapses of high-speed imaging photographs showing the evolution of the contact line for the low-phi surface with a plastron layer (top) and the low-phi surface without a plastron layer (bottom).

FIG. 15A shows, in accordance with certain embodiments, time lapse images taken from high-speed imagery showing the capture and absorption of a CO₂ bubble into a superaerophilic low-phi surface, wherein the scale bar is 5 mm.

FIG. 15B shows, in accordance with certain embodiments, average reaction rates for various capture surfaces tested, showing a two order of magnitude improvement in the reaction rate for the low-phi spreading bubble case in comparison with b5 micropost textured, smooth teflon, and smooth silicon capture surfaces. It is noted that the average reaction rates shown for all surfaces other than low-phi represent the initial 20 seconds of absorption, as the tested bubbles plateaued in absorption at some point after this time and were never completely absorbed like the low-phi case.

FIG. 15C shows, in accordance with certain embodiments, average reaction rates for the low-phi spreading bubble case measurements in comparison to predictions from the model, which are in good order of magnitude agreement to show the improvement relative to the non-spreading bubble case.

FIG. 15D shows, in accordance with certain embodiments, time lapse, high-speed imaging of the smallest bubbles directly injected into a low-phi capture surface showing total absorption of ˜1 ms for these small bubbles, wherein the scale bar is 1 mm.

FIG. 15E shows, in accordance with certain embodiments, a schematic diagram of an array of needles to create a modular embodiment of the surface enhanced direct injection absorption system (left) and volumetrically normalized reaction rates (right), which take into account the size occupied by the absorption reactor for the envisioned small-scale surface enhanced direct injection absorber in comparison to a commercial reference, Petra Nova's absorption tower, which is a large-scale post-combustion carbon capture facility in Texas, USA.

FIG. 16A shows, in accordance with certain embodiments, convergence of bubble dissolution time via spatial mesh refinement for a spherical non-spreading bubble model geometry.

FIG. 16B shows, in accordance with certain embodiments, convergence of bubble dissolution time via spatial mesh refinement for a planar spreading bubble model geometry.

FIG. 17A shows, in accordance with certain embodiments, convergence of bubble dissolution time via temporal mesh refinement for a spherical non-spreading bubble model geometry.

FIG. 17B shows, in accordance with certain embodiments, convergence of bubble dissolution time via temporal mesh refinement for a planar spreading bubble model geometry.

FIG. 18 shows, in accordance with certain embodiments, the molar flux from solution of the model developed in high agreement with literature values for short reaction times of 0.05 seconds and long reaction times of 10 seconds. Reference for data comparison from * is Sherwood, T. K., Pigford, R. L., & Wilke, C. R. (1975). Mass Transfer. McGraw-Hill.

FIG. 19 shows, in accordance with certain embodiments, a photograph of an experimental setup for delivering single bubbles to capture surfaces during experiments.

FIG. 20 shows, in accordance with certain embodiments, a schematic diagram of a setup used to enable single bubble control via pressure regulated gas flow of CO₂.

FIG. 21 shows, in accordance with certain embodiments, a table of the boundary and initial conditions used for numerical modeling, where H represents the Henry's Law constant for CO₂, c_{CO}_{₂}, and c_{OH}_{^{−}} are the concentrations of the carbon dioxide gas and hydroxide ions present in the system, respectively, t is the time variable, and r is the spatial radial variable for a spherical coordinate system. R represents the radius of the bubble and c_{bulk, OH}_{^{−}} represents the bulk concentration of hydroxide ions in the system.

FIG. 22 shows, in accordance with certain embodiments, a table of the physical constants and material properties used in numerical modeling.

### DETAILED DESCRIPTION

Articles, systems, and methods for dissolving a gas in a liquid medium and/or reacting a gas with one or more components within a liquid medium are generally described. According to certain embodiments, nanoengineered surfaces having certain wetting properties with respect to a liquid medium in which bubbles are formed can be used to capture and spread the bubbles when the nanoengineered surface is at least partially submerged in the liquid medium. In certain embodiments, the nanoengineered surface is non-wetting with respect to the liquid medium in which the bubbles are formed. When at least partially submerged in the liquid medium, the nanoengineered surface can, in some embodiments, capture and spread the bubbles such that the gas from within the bubbles dissolves in the liquid medium and/or reacts with one or more components within the liquid medium.

In one set of embodiments, the nanoengineered surface comprises a textured surface comprising a plurality of features (e.g., microscale and/or nanoscale features). The size of the features, shape of the features, and/or spacing of the features on the nanoengineered surface may affect the hydrophobicity of the nanoengineered surface such that the nanoengineered surface advantageously captures and spreads the bubbles. In some embodiments, for example, the nanoengineered surface is at least partially submerged in a liquid medium, and a gas is injected at or near the nanoengineered surface. The injected gas, in some embodiments, forms a bubble that contacts at least a portion of the features of the textured surface such that the bubble is captured by and spread on the nanoengineered surface. In some embodiments, for example, the bubble is captured by and spread on the plurality of features of the textured surface such that gas from within the bubble enters between the features. The spread bubble dissolves in the liquid medium and/or the gas from within the bubble reacts with one or more components within the liquid medium, in accordance with certain embodiments. Advantageously, the spreading of the bubble may increase the surface area per volume of gas (e.g., from within the bubble) available for dissolution within the liquid medium and/or reaction with the one or more components within the liquid medium.

According to certain embodiments, the nanoengineered surface at least partially submerged in the liquid medium comprises a gaseous fluidic pathway (e.g., a plastron layer) provided by arranging the features (e.g., microscale and/or nanoscale features) on the nanoengineered surface such that gas is trapped between the features. In some embodiments, a gas is injected at or near the nanoengineered surface (e.g., at or near the plastron layer). The injected gas may, in some embodiments, spread on the nanoengineered surface (e.g., through the plastron layer). For example, in some embodiments, the trapped gas positioned between the features can interact with the injected gas such that the injected gas merges with the trapped gas positioned between the features and becomes part of the plastron layer. In accordance with certain embodiments, the spread gas that has become part of the plastron layer dissolves in the liquid medium and/or reacts with one or more components within the liquid medium.

As noted above, certain embodiments are related to articles, systems, and methods for dissolving a gas in a liquid medium and/or reacting a gas with one or more components within a liquid medium. In certain embodiments, for example, the gas may comprise carbon dioxide (CO₂) and the liquid medium comprises an aqueous hydroxide solution. In some such embodiments, the articles, systems, and methods described herein may be used for CO₂ bubble absorption and/or reaction.

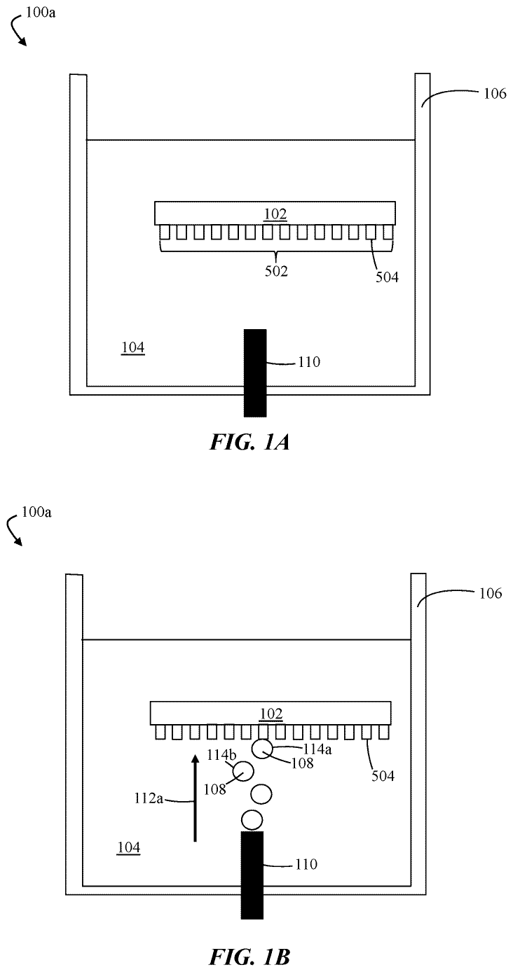

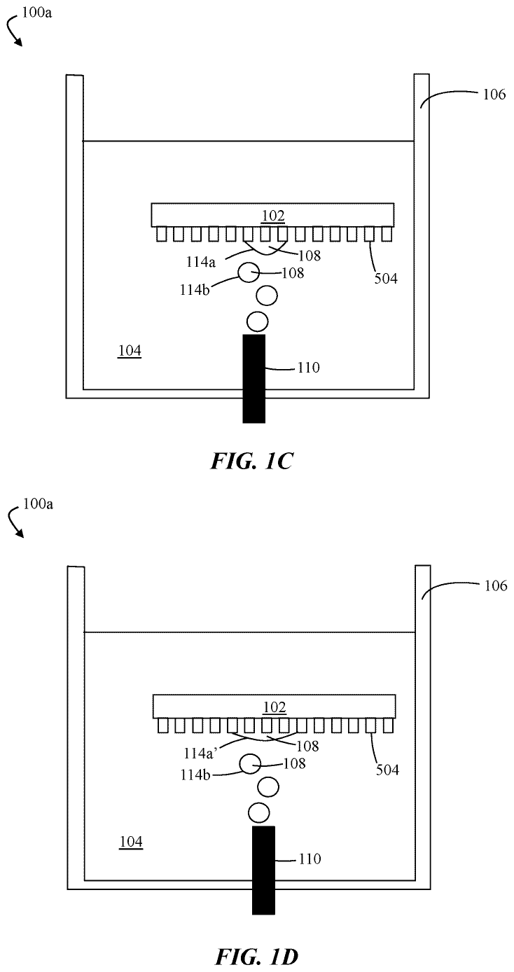

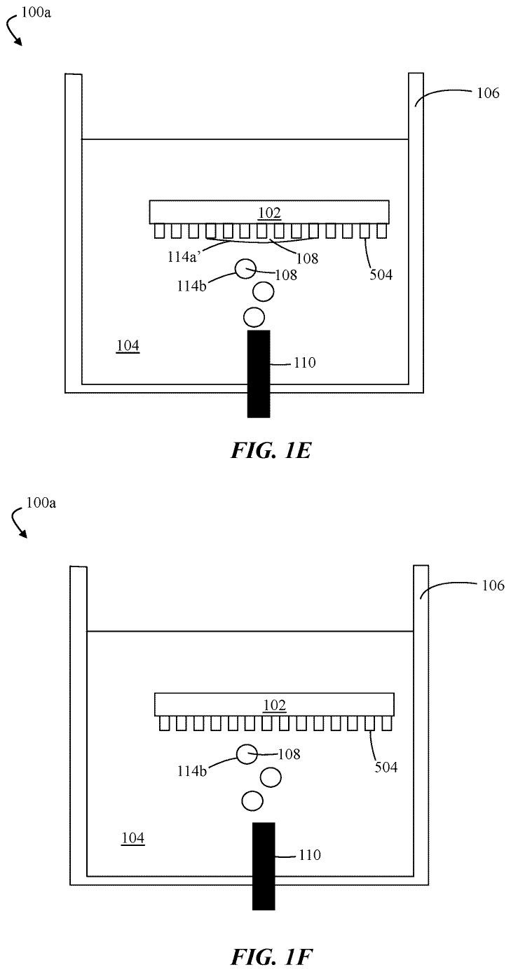

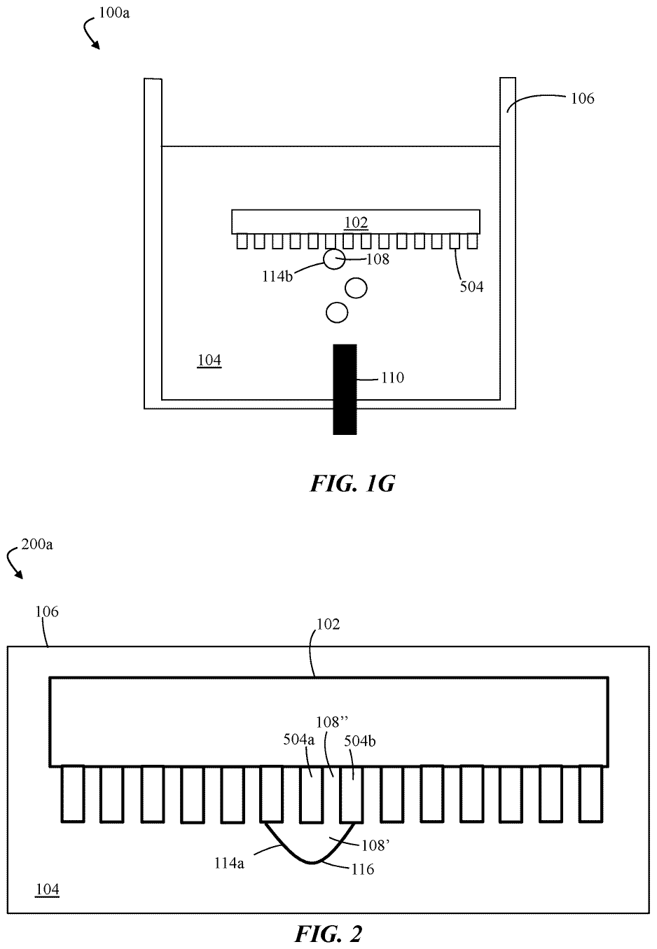

According to some embodiments, a method comprises contacting a nanoengineered surface with a liquid medium. FIG. 1A shows, in accordance with certain embodiments, a cross-sectional schematic diagram representing method 100a comprising contacting nanoengineered surface 102 with liquid medium 104.

According to certain embodiments, the nanoengineered surface is at least partially submerged in the liquid medium. In some embodiments, the nanoengineered surface is fully submerged in the liquid medium. As shown in FIG. 1A, for example, nanoengineered surface 102 is fully submerged in liquid medium 104. While the embodiment in FIG. 1A shows nanoengineered surface 102 fully submerged in liquid medium 104, in other embodiments, the nanoengineered surface can be partially submerged in the liquid medium, as described elsewhere herein.

Generally, a “nanoengineered surface” is one that comprises microscale and/or nanoscale features. The microscale and/or nanoscale features can impart a texture to the nanoengineered surface. Referring to FIG. 1A, for example, nanoengineered surface 102 comprises textured surface 502, wherein at least a portion of the textured surface comprises an arrangement of microscale features and/or nanoscale features. In certain embodiments, at least a portion of the nanoengineered surface comprises a microscale texture (e.g., an arrangement of microscale features). In some embodiments, at least a portion of the nanoengineered surface comprises a nanoscale texture (e.g., an arrangement of nanoscale features). In some embodiments, the nanoengineered surface comprise a microscale texture and not a nanoscale texture. In certain embodiments, the nanoengineered surface comprises a nanoscale texture and not a microscale texture. In some embodiments, the nanoengineered surface comprises a microscale texture and a nanoscale texture.

According to certain embodiments, the textured surface is at least partially submerged in the liquid medium as the nanoengineered surface is at least partially submerged in the liquid medium. For example, as shown in FIG. 1A, nanoengineered surface 102 is at least partially submerged (e.g., fully submerged) in liquid medium 104, and nanoengineered surface 102 comprises textured surface 502 which is at least partially submerged (e.g., fully submerged) in liquid medium 104.

In certain embodiments, the textured surface comprises a plurality of features. As shown in FIG. 1A, for example, textured surface 502 comprises a plurality of features 504. The features can include, according to certain embodiments, microscale features and/or nanoscale features. Any of a variety of suitable textures and/or features may be utilized for the nanoengineered surface. In some embodiments, the textured surface comprises protrusions (e.g., microscale protrusions, nanoscale protrusions). In certain embodiments, for example, the textured surface comprises a plurality of ridges, pores, spikes, pillars, and/or posts (e.g., microscale and/or nanoscale ridges, pores, spikes, pillars, and/or posts). Other textures and/or features are also possible. The textures and features of the nanoengineered surface are described in greater detail elsewhere herein.

According to certain embodiments, at least a portion of the nanoengineered surface is non-wetting with respect to the liquid medium. Referring to FIG. 1A, for example, at least a portion of nanoengineered surface 102 is non-wetting with respect to liquid medium 104. In some embodiments, for example, at least a portion of the nanoengineered surface is hydrophobic. Advantageously, embodiments in which at least a portion of the nanoengineered surface is hydrophobic may promote the capture and spreading of bubbles by the nanoengineered surface, as described in greater detail elsewhere herein.

The liquid medium can have any of a variety of suitable compositions. In certain embodiments, for example, the liquid medium comprises water. In some embodiments, the liquid medium comprises an aqueous solution. Referring, for example, to FIG. 1A, liquid medium 104 comprises an aqueous solution.

According to some embodiments, the liquid medium may comprise one or more components that are configured to react with a gas. In certain embodiments, the liquid medium comprises a hydroxide (OH). For example, in some embodiments, the liquid medium comprises an aqueous hydroxide solution. The liquid medium may comprise any of a variety of suitable hydroxide salts (e.g., dissolved hydroxide salts), such as, for example, KOH and/or NaOH. In certain embodiments wherein the liquid medium comprises a hydroxide, the hydroxide may be configured to react with CO₂. The liquid medium and the components thereof are explained in further detail elsewhere herein.

According to certain embodiments, the method comprises injecting a gas at or near the nanoengineered surface. FIG. 1B shows, in accordance with certain embodiments, a cross-sectional schematic diagram representing method 100a comprising injecting gas 108 at or near nanoengineered surface 102. In some embodiments, the gas is injected in a direction at or near the nanoengineered surface such that the gas is injected into the liquid medium at or near the nanoengineered surface. As shown in FIG. 1B, for example, gas 108 is injected in direction 112a at or near nanoengineered surface 102 such that gas 108 is injected into liquid medium 104 at or near nanoengineered surface 102.

In certain embodiments, the gas is injected at or near the nanoengineered surface via a source of gas. For example, referring to FIG. 1B, gas 108 is injected at or near nanoengineered surface 102 via source of gas 110. According to some embodiments, the source of gas is within and/or in fluidic communication with the liquid medium. Referring to FIG. 1B, for example, source of gas 110 is within and in fluidic communication with liquid medium 104. The source of gas is described elsewhere herein in greater detail.

The gas may comprise any of a variety of suitable gases. In certain embodiments, the gas is an air pollutant. Non-limiting examples of gases include, in some embodiments, carbon dioxide (CO₂), dioxygen (O₂), ozone (O₃), dinitrogen (N₂), hydrogen (H₂), a nitrogen oxide (NOₓ), sulfur dioxide (SO₂), carbon monoxide (CO), and/or combinations thereof. Other gases are also possible.

According to certain embodiments, the injected gas forms bubbles. Referring, for example, to FIG. 1B, injected gas 108 forms bubbles 114 (e.g., bubbles 114a and 114b). As used herein, the term “bubble” is given its ordinary meaning in the art and refers to a gaseous phase surrounded by a liquid. According to certain embodiments, a bubble can have any suitable shape, such as spherical, deviational from spherical, or ellipsoidal. As used herein, an “emulsion” (i.e., a first liquid phase surrounded by a second liquid phase, such as in an oil-in-water emulsion or a water-in-oil emulsion) is not a “bubble.”

In some embodiments, the bubbles are transported from the source of gas (e.g., the source of bubbles), through the liquid medium, to the at least partially submerged nanoengineered surface when the nanoengineered surface is at least partially submerged in the liquid medium. For example, as shown in FIG. 1B, bubbles 114 are transported from source of gas 110, through liquid medium 104, to nanoengineered surface 102 when nanoengineered surface 102 is at least partially submerged (e.g., fully submerged) in liquid medium 104. In certain embodiments, the bubbles are transported proximate the nanoengineered surface. Referring to FIG. 1B, for example, bubble 114a is transported from source of gas 110 and through liquid medium 104 until bubble 114a is proximate nanoengineered surface 102.

According to some embodiments, the bubbles are transported from the source of gas directly to the at least partially submerged nanoengineered surface when the nanoengineered surface is at least partially submerged in the liquid medium. In certain embodiments, for example, the source of gas is positioned proximate the nanoengineered surface such that the injected gas forms a bubble that contacts a portion of the nanoengineered surface as the bubble is formed.

According to some embodiments, the bubbles are captured by and spread on the nanoengineered surface. FIGS. 1C-1E show, in accordance with certain embodiments, cross-sectional schematic diagrams representing a method wherein bubble 114a is captured by and spread on nanoengineered surface 102. As explained in further detail below, in certain embodiments, as bubble 114a (as shown in FIG. 1C) is captured by and spread on nanoengineered surface 102, bubble 114a forms spread bubble 114a′ (as shown in FIGS. 1D-1E).

According to certain embodiments, the bubbles are captured by the nanoengineered surface. In some embodiments, the nanoengineered surface is non-wetting with respect to the liquid in which the bubbles are formed, as explained in greater detail elsewhere herein. Without wishing to be bound by any particular theory, the non-wetting (e.g., hydrophobic) nature of the nanoengineered surface with respect to the liquid (e.g., aqueous solution) in which the bubbles are formed allows the nanoengineered surface to capture the bubble, in accordance with certain embodiments.

In some embodiments, a wall of the bubble is breached once the bubble has been captured by the nanoengineered surface. FIG. 2 shows, in accordance with certain embodiments, a cross-sectional schematic diagram illustrating the interaction of a bubble 114a with nanoengineered surface 102. As shown in FIG. 2, in system 200a, bubble 114a has been captured by nanoengineered surface 102, and wall 116 of bubble 114a has been breached, in accordance with certain embodiments. Without wishing to be bound by any particular theory, the wall of the bubble may be breached due to the non-wetting (e.g., hydrophobic) nature of the nanoengineered surface with respect to the liquid (e.g., aqueous solution) in which the bubbles are formed.

In certain embodiments, the bubbles are spread on the nanoengineered surface. According to some embodiments, the gas from within the bubble enters between the features of the nanoengineered surface after the bubble has been captured by the nanoengineered surface and the wall of the bubble has been breached. For example, referring to FIG. 2, gas 108′ from within bubble 114a enters between features 504a and 504b as gas 108″, which had been contained within bubble 114a before wall 116 of bubble 114a was breached.

In certain embodiments, as the gas from within the bubble enters between the features of the nanoengineered surface, the bubble spreads on the nanoengineered surface, thereby forming the spread bubble. Referring to FIGS. 1C-1E, for example, gas 108 from within bubble 114a (as shown in FIG. 1C) enters between features 504 of nanoengineered surface 102, thereby forming spread bubble 114a′ (as shown in FIGS. 1D-1E). In some embodiments, the spread bubble forms a layer of gas over the features. For example, referring to FIGS. 1D-1E, spread bubble 114a′ forms a layer of gas 108 over features 504. In some embodiments, the spread bubble (e.g., the layer of gas) is continuous across the nanoengineered surface. Referring, for example, to FIGS. 1D-1E, spread bubble 114a′ (e.g., layer of gas 108) is continuous across nanoengineered surface 102.

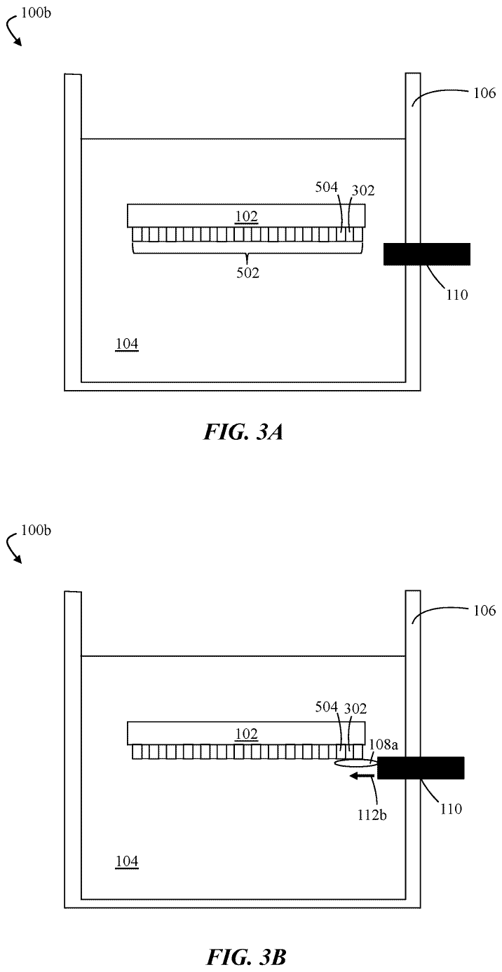

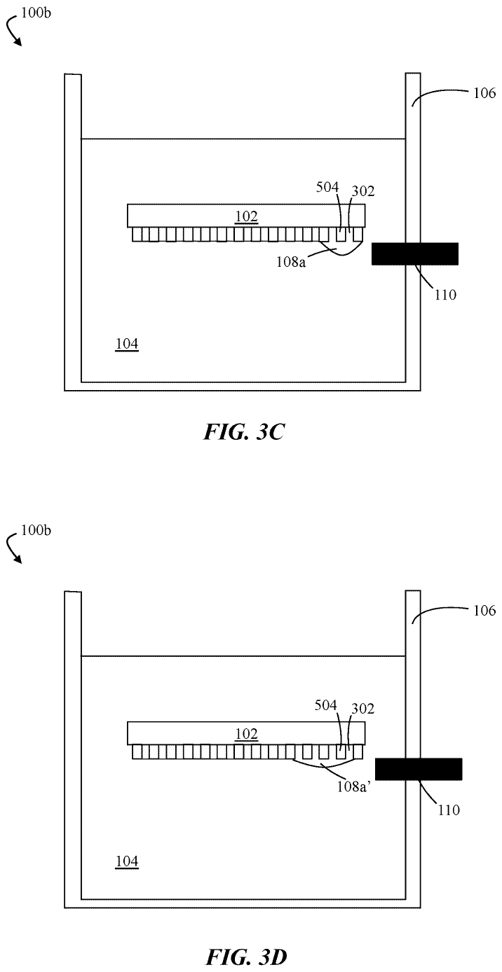

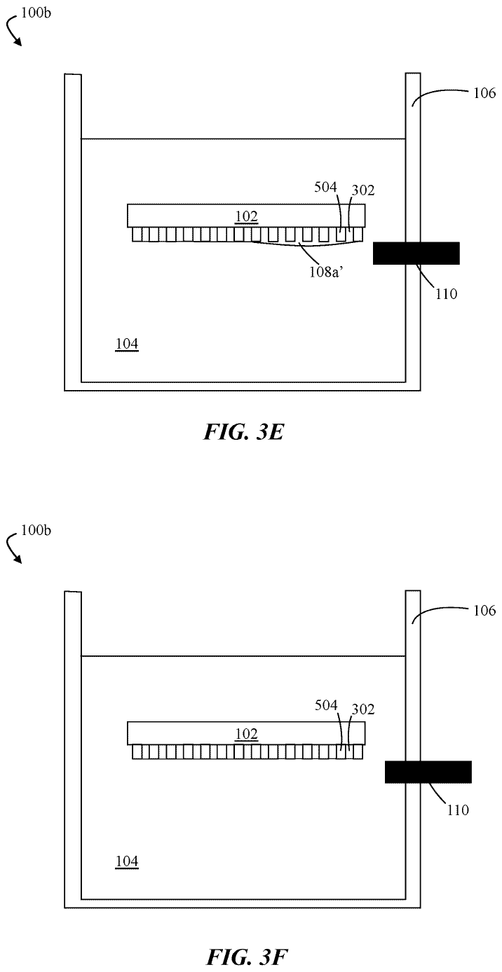

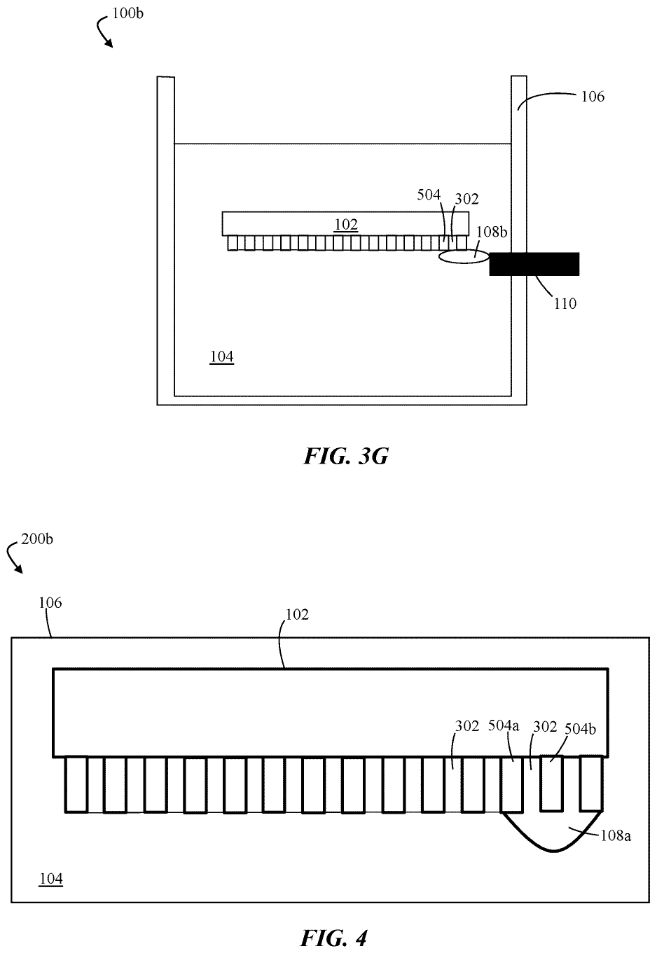

According to certain embodiments, as the gas from within the bubble enters between the features of the nanoengineered surface, the gas between the features of the nanoengineered surface forms a plastron layer, which is described herein in greater detail with respect to FIGS. 3A-5C.

In certain embodiments, the spread bubbles dissolve in the liquid medium and/or react with one or more components within the liquid medium. FIG. 1F shows, in accordance with certain embodiments, a cross-sectional schematic diagram representing a method wherein spread bubble 114a′ (as shown in FIGS. 1D-1E) dissolves in liquid medium 104 and/or reacts with one or more components within liquid medium 104.

According to certain embodiments, the spread bubbles dissolve in the liquid medium. In certain embodiments, for example, the liquid in which the bubbles are formed dissolves in the liquid medium after the bubble has been captured by and spread on the nanoengineered surface and the gas from within the bubble enters between the features on the nanoengineered surface. Referring, for example, to FIGS. 1C-1F, in certain embodiments, as gas 108 from within bubble 114a enters between features 504 of nanoengineered surface 102 and spread bubble 114′ is formed, spread bubble 114′ dissolves in liquid medium 104. In some embodiments, the liquid in which the bubbles are formed and/or the gas from within the bubble is absorbed by the liquid medium. According to certain embodiments, the gas from within the bubbles is absorbed by the liquid medium until the concentration of the dissolved gas within the liquid medium reaches saturation and/or supersaturation.

According to some embodiments, the spread bubbles react with one or more components within the liquid medium. In certain embodiments, for example, the gas from within the bubble reacts with one or more components within the liquid medium after the bubble has been captured by and spread on the nanoengineered surface and the gas from within the bubbles enters between the features on the nanoengineered surface.

For example, as shown in FIGS. 1C-1F, in some embodiments, as gas 108 from within bubble 114a enters between features 504 of nanoengineered surface 102 and spread bubble 114′ is formed, gas 108 reacts with one or more components within liquid medium 104. Without wishing to be bound by any particular theory, the spreading of the bubble advantageously increases the surface area per volume of gas (e.g., from within the bubble) available for the reaction with the one or more components within the liquid medium. In some embodiments, the reaction between the gas from within the bubble and the one or more components within the liquid medium is irreversible. According to some embodiments, the gas from within the bubbles may react with the one or more components within the liquid medium until there is no reactant in the liquid medium.

As explained in greater detail above, the liquid medium may comprise an aqueous hydroxide solution, and the gas from within the bubble may comprise CO₂, in accordance with certain embodiments. In some such embodiments, the aqueous hydroxide solution and the gas from within the bubble (e.g., CO₂) may react according to equation 1 (eq. 1) shown below.

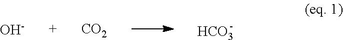

According to certain embodiments, the HCO₃⁻ bicarbonate product dissolves in the aqueous solution as it is formed from the reaction between OH and CO₂.

Other components within the liquid medium that are configured to react with one or more gases are also possible.

In certain embodiments, only one bubble at a time is captured by and spread on the nanoengineered surface. According to certain embodiments, for example, after the spread bubble dissolves in the liquid medium and/or reacts with one or more components within the liquid medium, a second bubble may be transported from the source of gas to the nanoengineered surface. FIG. 1G is, in accordance with certain embodiments, a cross-sectional schematic diagram representing a method wherein a second bubble is captured by a nanoengineered surface. Referring, for example, to FIG. 1G, after spread bubble 114a′ (as shown in FIGS. 1D-1E) dissolves in liquid medium 104 and/or reacts with one or more components within liquid medium 104, second bubble 114b may be transported from source of gas 110 to nanoengineered surface 102. The second bubble may, in some embodiments, be captured by and spread on the nanoengineered surface, as explained herein in greater detail with respect to FIGS. 1C-1E. In some embodiments, the spread second bubble dissolves in the liquid medium and/or reacts with one or more components within the liquid medium, as explained herein in greater detail with respect to FIG. 1F. Advantageously, configuring the system in this way allows multiple bubbles to be cyclically captured by and spread on the nanoengineered surface over time. In certain embodiments, multiple bubbles may be cyclically captured by and spread on the nanoengineered surface until there is no reactant in the liquid medium and/or the concentration of the dissolved gas within the liquid medium reaches saturation and/or supersaturation. The gas within the second bubble may, in some embodiments, be the same as the gas within the first bubble. In other embodiments, the gas within the second bubble is different than the gas within the first bubble.

According to certain embodiments, the nanoengineered surface at least partially submerged in the liquid medium is associated with a plastron layer. FIG. 3A shows, in accordance with certain embodiments, a cross-sectional schematic diagram representing method 100b comprising contacting nanoengineered surface 102 with liquid medium 104, wherein nanoengineered surface 102 is associated with plastron layer 302.

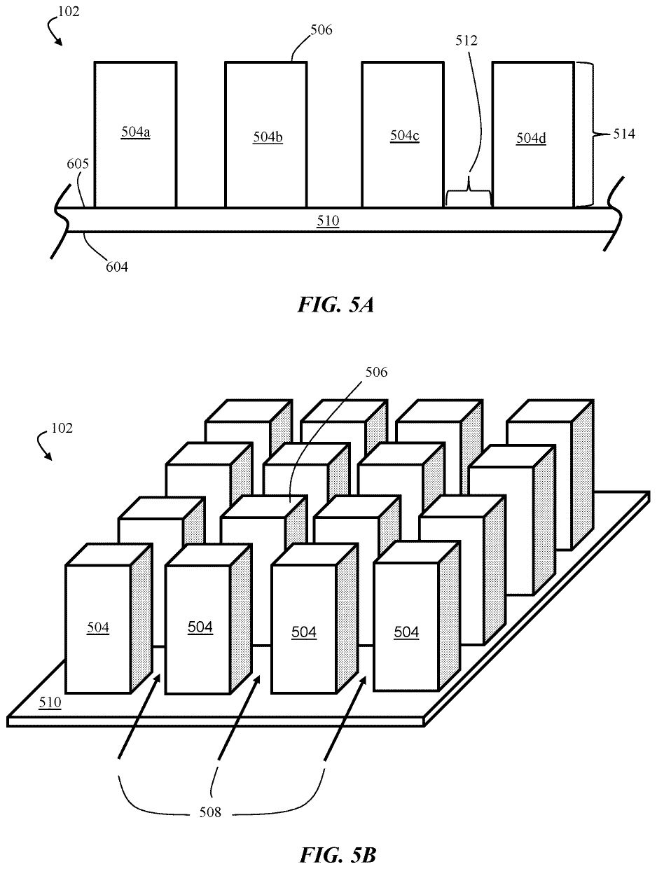

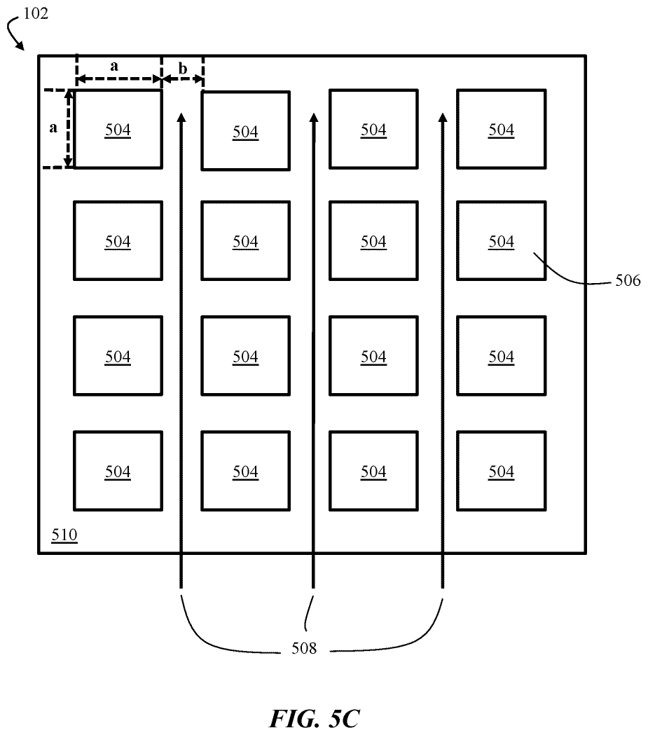

As used herein, the term “plastron layer” refers to trapped gas positioned between the features of the nanoengineered surface that forms a continuous gaseous fluidic pathway between the features adjacent to the nanoengineered surface. One example of such a plastron layer can be understood in reference to FIGS. 4 and 5A-5C. FIG. 4 shows, in accordance with certain embodiments, a cross-sectional schematic diagram illustrating the interaction of gas 108a with nanoengineered surface 102 associated with plastron layer 302. FIG. 5A shows, in accordance with certain embodiments, a cross-sectional schematic diagram of a nanoengineered surface. FIG. 5B shows a perspective view schematic diagram of the nanoengineered surface shown in FIG. 5A. FIG. 5C shows a top view schematic diagram of the nanoengineered surface shown in FIGS. 5A-5B. Referring to FIG. 4, in system 200b, nanoengineered surface 102 is submerged in liquid medium 104, and gas positioned between features 504 (e.g., feature 504a and 504b) is trapped between features 504 (e.g., 504a and 504b), thereby forming plastron layer 302, in accordance with certain embodiments. As shown in FIGS. 5B-5C, in some embodiments, the trapped gas between features 504 forms continuous gaseous fluidic pathway 508. According to certain embodiments, plastron layer 302 remains stable in liquid medium 104 due to capillary forces between exposed surface 506 of features 504 and liquid medium 104.

According to certain embodiments, the trapped gas positioned between the features of the nanoengineered surface (e.g., the plastron layer) comprises gas that was previously contained within a bubble formed by injecting gas through the source of gas. Referring to FIG. 3A, for example, plastron layer 302 may comprise gas that was previously contained within a bubble formed by injecting gas through source of gas 110, wherein the bubble is captured by and spread on the nanoengineered surface (as explained herein with respect to FIGS. 1B-1E). The plastron layer may comprise any of a variety of suitable gases. In some embodiments, for example, the plastron layer comprises CO₂, O₂, O₃, N₂, H₂, a NOₓ, SO₂, CO, and/or combinations thereof. In some non-limiting embodiments, plastron layer 302 comprises CO₂. In certain non-limiting embodiments, plastron layer 302 comprises O₂.

In some embodiments, the method comprises injecting a gas (e.g., CO₂, O₂) at or near the nanoengineered surface (e.g., at or near the plastron layer). FIG. 3B shows, in accordance with certain embodiments, a cross-sectional schematic diagram representing method 100b comprising injecting gas 108a at or near nanoengineered surface 102 associated with plastron layer 302. In some embodiments, gas 108a is injected at or near plastron layer 302. In some embodiments, the gas is injected in a direction at or near the nanoengineered surface such that the gas is injected into the liquid medium at or near the plastron layer. For example, as shown in FIG. 3B, gas 108a is injected in direction 112b at or near nanoengineered surface 102 such that gas 108a is injected into liquid medium 104 at or near plastron layer 302.

According to certain embodiments, the gas is injected at or near the nanoengineered surface (e.g., at or near the plastron layer) via a source of gas. In some embodiments, the source of gas is within and/or in fluidic communication with the liquid medium. Referring to FIG. 3B, for example, gas 108a is injected at or near nanoengineered surface 102 (e.g., at or near plastron layer 302) via source of gas 110, which is within and in fluidic communication with liquid medium 104.

In some embodiments, the injected gas is transported from the source of gas directly to the nanoengineered surface (e.g., to the plastron layer) when the nanoengineered surface is at least partially submerged in the liquid medium. In certain embodiments, for example, the source of gas is positioned proximate the nanoengineered surface such that the injected gas contacts a portion of the nanoengineered surface (e.g., a portion of the plastron layer). As shown in FIG. 3B, for example, source of gas 110 is positioned proximate nanoengineered surface 102 such that injected gas 108a contacts a portion of nanoengineered surface 102 (e.g., a portion of plastron layer 302). According to some embodiments, the injected gas may contact a portion of nanoengineered surface (e.g., a portion of the plastron layer) without forming a freestanding bubble in the liquid medium.

In some embodiments, the injected gas forms bubbles. According to some embodiments, the bubbles are transported from the source of gas, through the liquid medium, to the nanoengineered surface associated with the plastron layer when the nanoengineered surface is at least partially submerged in the liquid medium. In some embodiments, the bubbles are transported proximate the nanoengineered surface associated with the plastron layer. For example, in certain embodiments, the bubbles are transported from the source of gas and through the liquid medium until the bubble is proximate the nanoengineered surface associated with the plastron layer. In certain embodiments, the bubble may be captured by and spread on the nanoengineered surface (as explained herein with respect to FIGS. 1D-1E) such that the gas from within the bubble contacts a portion of the plastron layer.

In some embodiments, the injected gas spreads on the nanoengineered surface such that the injected gas spreads through the plastron layer. FIG. 3C-3E show, in accordance with certain embodiments, cross-sectional schematic diagrams representing a method wherein injected gas 108a spreads on nanoengineered surface 102 such that injected gas 108a spreads through plastron layer 302. In certain embodiments, as injected gas 108a (as shown in FIG. 3C) spreads through plastron layer 302, injected gas 108a forms spread gas 108a′ (as shown in FIGS. 3D-3E). According to certain embodiments, the spread gas forms a layer of gas over the features. For example, referring to FIGS. 3D-3E, spread 108a′ forms layer of gas 108a′ over features 504. In some embodiments, the spread gas (e.g., the layer of gas) is continuous across the nanoengineered surface. Referring, for example, to FIGS. 3D-3E, spread gas 108a′ (e.g., layer of gas 108a) is continuous across nanoengineered surface 102.

According to some embodiments, the trapped gas positioned between the features of the nanoengineered surface (e.g., the plastron layer) can interact with the injected gas. As shown in FIG. 4, for example, the trapped gas positioned between features 504a and 504b (e.g., plastron layer 302) interacts with injected gas 108a.

According to certain embodiments, the injected gas merges with the trapped gas positioned between the features of the nanoengineered surface (e.g., the plastron layer). For example, referring to FIG. 4, injected gas 108a merges with the trapped gas positioned between features 504a and 504b (e.g., plastron layer 302), which may form a part of continuous gaseous fluidic pathway 508 (shown in FIGS. 5B-5C). In certain embodiments, the injected gas merges with the trapped gas positioned between the features (e.g., the plastron layer) such that the injected gas spreads through and becomes part of the plastron layer.

In some embodiments, the spread gas dissolves in the liquid medium and/or reacts with one or more components within the liquid medium. FIG. 3F shows, in accordance with certain embodiments, a cross-sectional schematic diagram representing method 100b wherein spread gas 108a′ (as shown in FIGS. 3D-3E) dissolves in liquid medium 104 and/or reacts with one or more components within liquid medium 104.

According to some embodiments, at least a portion of the spread gas dissolves in the liquid medium. In certain embodiments, for example, at least a portion of the spread gas that has become part of the plastron layer dissolves in the liquid medium. For example, referring to FIGS. 3C-3F, in certain embodiments, as injected gas 108a spreads through and becomes part of plastron layer 302 and spread gas 108a′ is formed, at least a portion of spread gas 108a′ dissolves in liquid medium 104. In some embodiments, at least a portion of the spread gas that has become part of the plastron layer is absorbed by the liquid medium. In certain embodiments, the spread gas is absorbed by the liquid medium until the concentration of the dissolved gas within the liquid medium reaches saturation and/or supersaturation.

According to certain embodiments, at least a portion of the spread gas reacts with one or more components within the liquid medium. In some embodiments, for example, at least a portion of the spread gas that has become part of the plastron layer reacts with one or more components within the liquid medium. For example, referring to FIGS. 3C-3F, in some embodiments, as injected gas 108a spreads through and becomes part of plastron layer 302 and spread gas 108a′ is formed, at least a portion of spread gas 108a′ reacts with one or more components within liquid medium 104. In some embodiments, the reaction between the spread gas and the one or more components within the liquid medium is irreversible. According to some embodiments, the spread gas may react with the one or more components within the liquid medium until there is no reactant in the liquid medium.

As explained in greater detail above, the liquid medium may comprise an aqueous hydroxide solution, and the spread gas (e.g., the injected gas that has spread through and become part of the plastron layer) may comprise CO₂, in accordance with certain embodiments. In some such embodiments, the aqueous hydroxide solution and the CO₂ may react according to eq. 1 shown above.

According to certain embodiments, after at least a portion of the spread gas dissolves in the liquid medium and/or reacts with one or more components within the liquid medium, a second gas may be injected at or near the nanoengineered surface associated with the plastron layer. FIG. 3G is, in accordance with certain embodiments, a cross-sectional schematic diagram representing a method wherein a second gas is injected at or near a nanoengineered surface associated with a plastron layer. Referring to FIG. 3G, for example, after spread gas 108a′ (as shown in FIGS. 3D-3E) dissolves in liquid medium 104 and/or reacts with one or more components within liquid medium 104, second gas 108b may be injected from source of gas 110 at or near nanoengineered surface 102 (e.g., at or near plastron layer 302). The second gas may, in some embodiments, spread on the nanoengineered surface (e.g., through the plastron layer), as explained herein in greater detail with respect to FIGS. 3C-3E. In some embodiments, the spread gas from the second gas dissolves in the liquid medium and/or reacts with one or more components within the liquid medium, as explained herein in greater detail with respect to FIG. 3F. Configuring the system in this way advantageously allows the plastron layer to be continuously replenished with gas over time as the gas concurrently dissolves in the liquid medium and/or reacts with one or more components within the liquid medium. In certain embodiments, the plastron layer may be continuously replenished over time until there is no reactant in the liquid medium and/or the concentration of the dissolved gas within the liquid medium reaches saturation and/or supersaturation. The second gas may, in some embodiments, be the same as the first gas. In other embodiments, the second gas is different than the first gas.

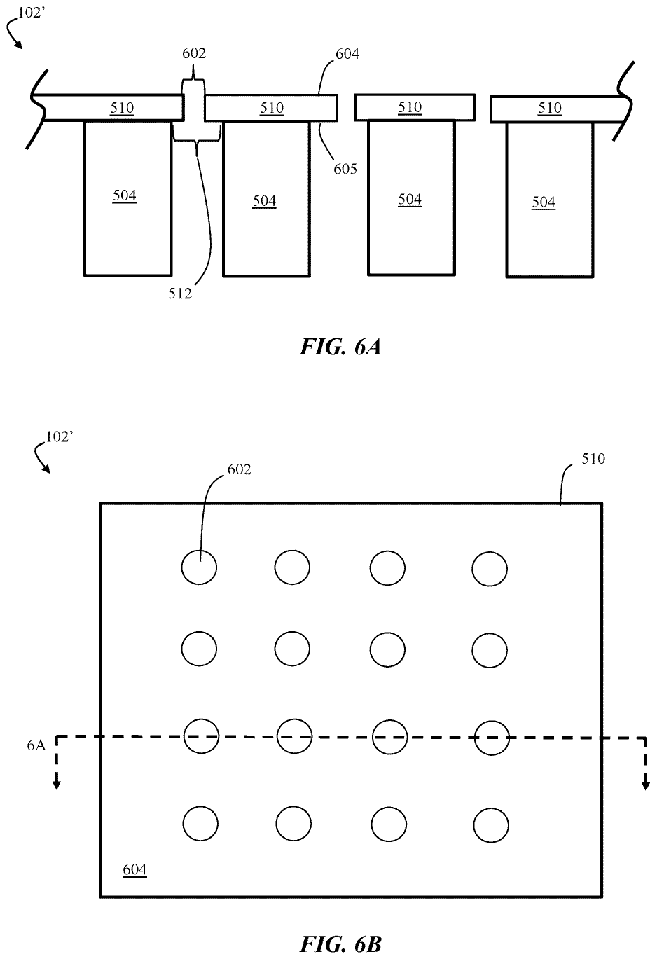

According to some embodiments, the nanoengineered surface comprises one or more perforations. FIG. 6A is, in accordance certain embodiments, a cross-sectional schematic diagram of nanoengineered surface 102′ comprising one or more perforations 602. In some embodiments, the nanoengineered surface comprises a substate and features disposed on the substrate. As shown in FIG. 6A, for example, nanoengineered surface 102′ comprises substrate 510 and features 504 disposed on substrate 510. In some embodiments, the substrate comprises a first surface and a second surface that is substantially opposite the first surface. For example, referring to FIG. 6A, substrate 510 comprises first surface 604 and second surface 605 that is substantially opposite first surface 604. In some embodiments, the features are disposed on the second surface of the substrate. As shown in FIG. 6A, for example, features 504 are disposed on second surface 605 of substrate 510.

According to some embodiments, the substrate comprises one more perforations. For example, referring to FIG. 6A, substrate 510 comprises perforations 602. In some embodiments, the perforations extend from the first surface of the substrate to the second surface of the substrate that is substantially opposite the first surface. As shown in FIG. 6A, for example, perforations 602 extend from first surface 604 of substrate 510 to second surface 605 of substrate 510 that is substantially opposite first surface 604.

The one or more perforations may be formed in the spacing between the features of the nanoengineered surface. For example, referring to FIG. 6A, perforations 602 are formed in spacing 512 between features 504 of nanoengineered surface 102′.

FIG. 6B is, in accordance with certain embodiments, a top view schematic diagram of a nanoengineered surface shown in FIG. 6A, wherein the cross-section in FIG. 6A is taken along dashed line 6A in FIG. 6B. As shown in FIG. 6B, substrate 510 comprises perforations 602 extending from first surface 604 of substrate 510 to the second surface (hidden from view in FIG. 6B) of substrate 510 that is substantially opposite first surface 604.

The nanoengineered surface may comprise any of a variety of suitable perforations. According to certain embodiments, for example, the perforations may be holes, apertures, slits, or the like. Other perforations are also possible.

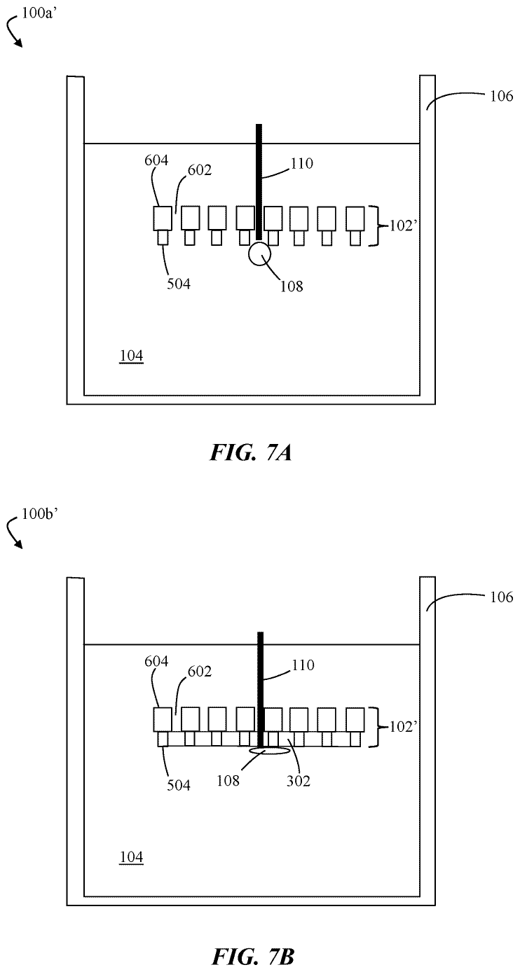

In certain embodiments, injecting the gas comprises delivering the gas through the one or more perforations in the nanoengineered surface. FIG. 7A is, in accordance with certain embodiments, a cross-sectional schematic diagram representing method 100a′ comprising injecting gas 108 through perforation 602 in nanoengineered surface 102′. In some embodiments, the gas is delivered through the one or more perforations in the nanoengineered surface via a source of gas. Referring, for example, to FIG. 7A, gas 108 is delivered through perforation 602 in nanoengineered surface 102′ via source of gas 110.

According to certain embodiments, after delivering the gas through the one or more perforations in the nanoengineered surface, the injected gas forms bubbles, as explained herein in greater detail with respect to FIG. 1B. In certain embodiments, the bubbles are captured by and spread on the nanoengineered surface, as explained herein in greater detail with respect to FIGS. 1C-1E. In some embodiments, the spread bubbles dissolve in the liquid medium and/or react with one or more components within the liquid medium, as explained herein in greater detail with respect to FIG. 1F.

According to some embodiments, injecting the gas comprises delivering the gas through the one or more perforations in the nanoengineered surface, wherein the nanoengineered surface is associated with a plastron layer. FIG. 7B is, in accordance with certain embodiments, a cross-sectional schematic diagram representing method 100b′ comprising injecting gas 108 through perforation 602 in nanoengineered surface 102′, wherein nanoengineered surface 102′ is associated with plastron layer 302. In some embodiments, the gas is delivered through the one or more perforations in the nanoengineered surface associated with a plastron layer via a source of gas. Referring, for example, to FIG. 7B, gas 108 is delivered through perforation 602 in nanoengineered surface 102′ associated with plastron layer 302 via source of gas 110.

According to certain embodiments, after delivering the gas through the one or more perforations in the nanoengineered surface, the injected gas contacts a portion of the nanoengineered surface (e.g., a portion of the plastron layer), as explained herein in greater detail with respect to FIG. 3B. In certain embodiments, the injected gas spreads on the nanoengineered surface such that the injected gas spreads through the plastron layer, as explained herein in greater detail with respect to FIGS. 3C-3E. In some embodiments, at least a portion of the spread gas dissolves in the liquid medium and/or reacts with one or more components within the liquid medium, as explained herein in greater detail with respect to FIG. 3F.

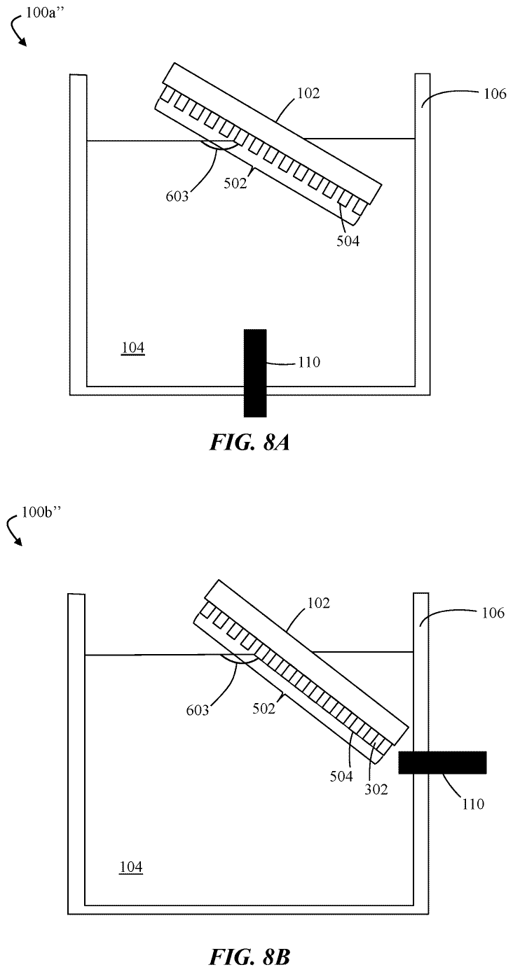

According to certain embodiments, the nanoengineered surface is partially submerged in the liquid medium. Without wishing to be bound by any particular theory, partially submerging the nanoengineered surface in the liquid medium may affect the rate at which bubbles in the liquid medium and/or injected gas interacts with the nanoengineered surface. FIG. 8A shows, in accordance with certain embodiments, a cross-sectional schematic diagram representing method 100a″ comprising contacting nanoengineered surface 102 with liquid medium 104, wherein nanoengineered surface 102 is partially submerged in liquid medium 104. FIG. 8B shows, in accordance with certain embodiments, a cross-sectional schematic diagram representing method 100b″ comprising contacting nanoengineered surface 102 associated with plastron layer 302 with liquid medium 104, wherein nanoengineered surface 102 is partially submerged in liquid medium 104.

As described elsewhere herein in greater detail with respect to FIG. 1F, the spread bubbles may dissolve in the liquid medium, in some embodiments. For example, in certain embodiments, the liquid in which the bubbles are formed and/or the gas from within the bubble dissolves in the liquid medium after the bubble has been captured by and spread on the nanoengineered surface and the gas from within the bubble enters between the features of the nanoengineered surface. As described elsewhere herein in greater detail with respect to FIG. 3F, at least a portion of the spread gas may dissolve in the liquid medium, in certain embodiments. In certain embodiments, for example, at least a portion of the spread gas that has become part of the plastron layer dissolves in the liquid medium.

The rate of dissolution of the gas (e.g., the gas from within the spread bubbles, the spread gas) may be any of a variety of suitable values. In certain embodiments, the rate of dissolution of the gas (e.g., the gas from within the spread bubbles, the spread gas) can be relatively fast. In some embodiments, for example, the rate of dissolution of the gas is greater than or equal to 10 microliters per second, greater than or equal to 50 microliters per second, greater than or equal to 100 microliters per second, greater than or equal to 500 microliters per second, greater than or equal to 1 milliliter per second, or greater than or equal to 5 milliliters per second. In certain embodiments, the rate of dissolution of the gas is less than or equal to 10 milliliters per second, less than or equal to 5 milliliters per second, less than or equal to 1 milliliter per second, less than or equal to 500 microliters per second, less than or equal to 100 microliters per second, or less than or equal to 50 microliters per second. Combinations of the above recited ranges are possible (e.g., the rate of dissolution of the gas is greater than or equal to 10 microliters per second and less than or equal to 10 milliliters per second, the rate of dissolution of the gas is greater than or equal to 500 microliters per second and less than or equal to 1 milliliter per second). Other ranges are also possible. The rate of dissolution of the gas may be determined by monitoring the increase in the concentration of the dissolved gas in the liquid medium.

As described herein in greater detail, the nanoengineered surface and the liquid medium may be contained within a container (e.g., a reactor, an absorber unit, etc.). The rate of dissolution of the gas may, in some embodiments, be normalized by the volume of the container. The minimum volume of the container may be any of a variety of suitable values. In some embodiments, for example, the minimum volume of the container may be at least 0.01 m³, at least 0.02 m³, at least 0.1 m³, at least 0.5 m³, at least 1 m³, or at least 5 m³. In certain embodiments, the minimum volume of the container may be less than or equal to 10 m³, less than or equal to 5 m³, less than or equal to 1 m³, or less than or equal to 0.5 m³. Combinations of the above recited ranges are possible (e.g., the minimum volume of the container is at least 0.01 m³ and less than or equal to 10 m³, the minimum volume of the container is at least 1 m³ and less than or equal to 5 m³). Other ranges are also possible.

The volumetric average rate of dissolution of the gas (e.g., the gas from within the spread bubbles, the spread gas) may be any of a variety of suitable values. In certain embodiments, for example, the volumetric average rate of dissolution of the gas is greater than or equal to 0.01 kg/s/m³, greater than or equal to 0.1 kg/s/m³, greater than or equal to 1 kg/s/m³, greater than or equal to 5 kg/s/m³, or greater than or equal to 10 kg/s/m³. In some embodiments, the volumetric average rate of dissolution of the gas is less than or equal to 20 kg/s/m³, less than or equal to 10 kg/s/m³, less than or equal to 5 kg/s/m³, less than or equal to 1 kg/s/m³, or less than or equal to 0.1 kg/s/m³. Combinations of the above recited ranges are possible (e.g., the volumetric average rate of dissolution of the gas is greater than or equal to 0.01 kg/s/m³ and less than or equal to 20 kg/s/m³, the volumetric average rate of dissolution of the gas is greater than or equal to 1 kg/s/m³ and less than or equal to 5 kg/s/m³). Other ranges are also possible. The volumetric average rate of dissolution of the gas may be determined by monitoring the increase in the concentration of the dissolved gas in the liquid medium and normalizing the average rate of dissolution by the volume of the container in which the liquid medium is contained.

As described elsewhere herein with respect to FIG. 1F, the spread bubbles may react with one or more components within the liquid medium, in some embodiments. In certain embodiments, for example, the gas from within the bubble reacts one or more components within the liquid medium after the bubble has been captured by and spread on the nanoengineered surface and the gas from within the bubbles enters between the features on the nanoengineered surface. As described elsewhere herein with respect to FIG. 3F, at least a portion of the spread gas may react with one or more components within the liquid medium, in some embodiments. In certain embodiments, for example, at least a portion of the spread gas that has become part of the plastron layer reacts with one or more components within the liquid medium.

According to some embodiments, a timescale of the spreading of the bubble and a timescale of the reaction between the gas from within the bubble and the one or more components within the liquid medium may be substantially similar, as defined by a modified Damköhler number, which is explained in greater detail below. In some embodiments, for example, a ratio of the timescale of the spreading of the bubble to the timescale of the reaction between the gas from within the bubble and the one or more components within the liquid medium may be, e.g., greater than or equal to 0.2 and less than or equal to 9. Without wishing to be bound by any particular theory, in certain embodiments, by substantially matching the timescale of the spreading of the bubble and the timescale of the reaction between the gas from within the bubble and the one or more components within the liquid medium, the spreading of the bubble enables the gas from within the bubble to be continuously supplied to the one or more components within the liquid medium over time.

In certain embodiments, the timescale of the spreading of the bubble is defined by equation 2 (eq. 2) shown below.

$${τ}_{spreading} = \frac{{a}^{2}}{{( g Ω )}^{1 / 2}} \qquad ( eq . 2 )$$

where a is the capillary length, g is the gravitational constant, and Ω is the volume of the spreading bubble.

According to certain embodiments, the capillary length is determined according to equation 3 (eq. 3) shown below.

$$a = \sqrt{\frac{σ}{( ρg )}} \qquad ( eq . 3 )$$

where σ is the surface tension of the interface between the nanoengineered surface and the liquid medium, ρ is the density of the liquid medium, and g is the gravitational constant.

The timescale of the spreading of the bubble may be any of a variety of suitable values. In some embodiments, for example, the timescale of the spreading of the bubble is greater than or equal to 2 ms, greater than or equal to 5 ms, greater than or equal to 10 ms, greater than or equal to 20 ms, greater than or equal to 50 ms, greater than or equal to greater than or equal to 100 ms, greater than or equal to 200 ms, or greater than or equal to 500 ms. In some embodiments, the timescale of the spreading of the bubbles is less than or equal to 1 second, less than or equal to 500 ms, less than or equal to 200 ms, less than or equal to 100 ms, less than or equal to 50 ms, less than or equal to 20 ms, less than or equal to 10 ms, or less than or equal to 5 ms. Combinations of the above recited ranges are possible (e.g., the timescale of the spreading of the bubble is greater than or equal to 2 ms and less than or equal to 1 second, the timescale of the spreading of the bubble is greater than or equal to 5 ms and less than or equal to 20 ms). Other ranges are also possible.

In some embodiments, the timescale of the reaction between the gas from within the bubble and the one or more components within the liquid medium is defined by equation 4 (eq. 4) shown below.

$${τ}_{rxn} = {( {c}_{bulk} k )}^{- 1} \qquad ( eq . 4 )$$

where c_{bulk} is the bulk concentration of reactant in the liquid medium and k is the reaction rate coefficient. The reaction rate coefficient may, in some embodiments, be determined by measuring the rate of reaction at various concentrations of reactant and fitting the data to an appropriate rate equation.

The timescale of the reaction between the gas from within the bubble and the one or more components within the liquid medium may be any of a variety of suitable values. In some embodiments, for example, the timescale of the reaction between the gas from within the bubble and the one or more components within the liquid medium is greater than or equal to 2 ms, greater than or equal to 5 ms, greater than or equal to 10 ms, greater than or equal to 20 ms, greater than or equal to 50 ms, greater than or equal to greater than or equal to 100 ms, greater than or equal to 200 ms, or greater than or equal to 500 ms. In some embodiments, the timescale of the reaction between the gas from within the bubble and the one or more components within the liquid medium is less than or equal to 1 second, less than or equal to 500 ms, less than or equal to 200 ms, less than or equal to 100 ms, less than or equal to 50 ms, less than or equal to 20 ms, less than or equal to 10 ms, or less than or equal to 5 ms. Combinations of the above recited ranges are possible (e.g., the timescale of the reaction between the gas from within the bubble and the one or more components within the liquid medium is greater than or equal to 2 ms and less than or equal to 1 second, the timescale of the reaction between the gas from within the bubble and the one or more components within the liquid medium is greater than or equal to 5 ms and less than or equal to 20 ms). Other ranges are also possible.

The ratio of the timescale of the spreading of the bubble to the timescale of the reaction between the gas from within the bubble and the one or more components of the liquid medium is defined by a modified Damköhler number, Da, as shown in equation 5 (eq. 5) below, wherein the timescale of the spreading of the bubble is divided by the timescale of the reaction between the gas from within the bubble and the one or more components of the liquid medium.

$$Da = \frac{{τ}_{spreading}}{{τ}_{rxn}} \qquad ( eq . 5 )$$

The modified Damköhler number may be any of a variety of suitable values. In some embodiments, for example, the modified Damköhler number is greater than or equal to 0.2, greater than or equal to 0.3, greater than or equal to 0.4, greater than or equal to 0.5, greater than or equal to 0.6, greater than or equal to 0.7, greater than or equal to 0.8, greater than or equal to 0.9, greater than or equal to 0.95, greater than or equal to 0.99, or greater than or equal to 1. In some embodiments, the modified Damköhler number is less than or equal to 9, less than or equal to 8, less than or equal to 7, less than or equal to 6, less than or equal to 5, less than or equal to 4, less than or equal to 3, less than or equal to 2, less than or equal to 1.9, less than or equal to 1.8, less than or equal to 1.7, less than or equal to 1.6, less than or equal to 1.5, less than or equal to 1.4, less than or equal to 1.3, less than or equal to 1.2, less than or equal to 1.1, less than or equal to 1.05, less than or equal to 1.02, or less than or equal to 1. Combinations of the above recited ranges are possible (e.g., the modified Damköhler number is greater than or equal to 0.2 and less than or equal to 9, the modified Damköhler number is greater than or equal to 0.9 and less than or equal to 1.1). Other ranges are also possible.

The rate of reaction of the gas (e.g., the gas from the spread bubbles, the spread gas) may be any of a variety of suitable values. In some embodiments, for example, the rate of reaction of the gas is greater than or equal to 10 microliters per second, greater than or equal to 50 microliters per second, greater than or equal to 100 microliters per second, greater than or equal to 500 microliters per second, greater than or equal to 1 milliliter per second, or greater than or equal to 5 milliliters per second. In certain embodiments, the rate of reaction of the gas is less than or equal to 10 milliliters per second, less than or equal to 5 milliliters per second, less than or equal to 1 milliliter per second, less than or equal to 500 microliters per second, less than or equal to 100 microliters per second, or less than or equal to 50 microliters per second. Combinations of the above recited ranges are possible (e.g., the rate of reaction of the gas is greater than or equal to 10 microliters per second and less than or equal to 10 milliliters per second, the rate of reaction of the gas is greater than or equal to 500 microliters per second and less than or equal to 1 milliliter per second). Other ranges are also possible. The rate of reaction of the gas may be determined by monitoring the volume of gas captured by the nanoengineered surface over time using video imaging and processing.

As described herein in greater detail, the nanoengineered surface and the liquid medium may be contained within a container (e.g., a reactor, an absorber unit, etc.). The rate of reaction of the gas may, in some embodiments, be normalized by the volume of the container. The minimum volume of the container may be any of a variety of suitable values as explained herein in greater detail (e.g., greater than or equal to 0.01 m³ and less than or equal to 10 m³).

The volumetric average rate of reaction of the gas (e.g., the gas from the spread bubbles, the spread gas) may be any of a variety of suitable values. In certain embodiments, for example, the volumetric average rate of reaction of the gas is greater than or equal to 0.01 kg/s/m³, greater than or equal to 0.1 kg/s/m³, greater than or equal to 1 kg/s/m³, greater than or equal to 5 kg/s/m³, or greater than or equal to 10 kg/s/m³. In some embodiments, the volumetric average rate of reaction of the gas is less than or equal to 20 kg/s/m³, less than or equal to 10 kg/s/m³, less than or equal to 5 kg/s/m³, less than or equal to 1 kg/s/m³, or less than or equal to 0.1 kg/s/m³. Combinations of the above recited ranges are possible (e.g., the volumetric average rate of reaction of the gas is greater than or equal to 0.01 kg/s/m³ and less than or equal to 20 kg/s/m³, the volumetric average rate of reaction of the gas is greater than or equal to 1 kg/s/m³ and less than or equal to 5 kg/s/m³). Other ranges are also possible. The volumetric average rate of reaction of the gas may be determined by monitoring the volume of gas captured by the nanoengineered surface over time using video imaging and processing and normalizing the average rate of reaction by the volume of the container in which the liquid medium is contained.

According to some embodiments, certain of the nanoengineered surfaces described herein are designed to have certain wetting properties that can be useful in dissolving a gas in a liquid medium and/or reacting a gas with one or more components within a liquid medium. In certain embodiments, the nanoengineered surface is non-wetting with respect to the liquid medium. For example, referring to FIG. 1A, nanoengineered surface 102 is non-wetting with respect to liquid medium 104. In certain embodiments, the nanoengineered surface is non-wetting with respect to the liquid that defines the wall of a bubble. Referring, for example, to FIG. 1B, nanoengineered surface 102 is non-wetting with respect to the liquid from which the wall of bubbles 114 are made.

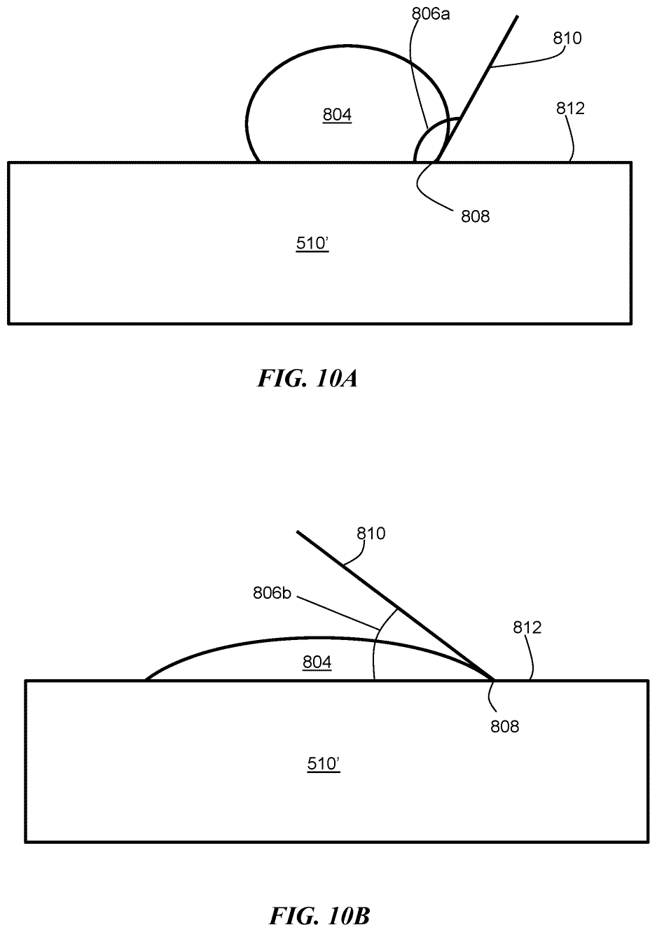

As used herein, a nanoengineered surface is considered to be non-wetting with respect to a liquid when, if a droplet of the liquid is positioned on the surface in a gaseous environment at the temperature and pressure at which the liquid and nanoengineered surface are being used, the droplet forms a contact angle, as measured through the bulk of the droplet, of greater than 90°. FIG. 10A shows an exemplary cross-sectional schematic diagram illustrating the interaction of liquid droplet 804 with surface 812 of substrate 510′ when surface 812 is non-wetting with respect to liquid droplet 804. As shown in FIG. 10A, contact angle 806a is measured between: (1) line 810 drawn tangent to the exterior surface of liquid droplet 804 at point of contact 808 with surface 812 of substrate 510′; and (2) surface 812 of substrate 510′. Contact angle 806a is measured through the bulk of liquid droplet 804. In FIG. 10A, contact angle 806a is greater than 90° (e.g., about 120°). This indicates that surface 812 of substrate 510′ is non-wetting with respect to liquid droplet 804. Conversely, FIG. 10B shows an exemplary cross-sectional schematic diagram illustrating the interaction of liquid droplet 303 with surface 812 of substrate 510′ when surface 812 is wetting with respect to liquid droplet 804. Contact angle 806b between liquid droplet 804 on surface 812 of substrate 510′ is less than 90° (e.g., about 50°), indicating that surface 812 of substrate 510′ is wetting with respect to liquid droplet 804.

According to certain embodiments, the nanoengineered surface is non-wetting with respect to the liquid medium at a temperature of 25° C. and at a pressure of 1 atmosphere.

Non-limiting examples of non-wetting surfaces include surfaces with properties understood by those of ordinary skill in the art. According to certain embodiments, for example, surfaces that are hydrophobic, oleophobic, metallophobic, omniphobic, superhydrophobic, superoleophobic, supermetallophobic, and/or superomniphobic can be used.

According to certain embodiments, the contact angle (e.g., water contact angle) between the nanoengineered surface and the liquid medium (e.g., aqueous solution) may be relatively large when the nanoengineered surface is non-wetting with respect to the liquid medium. In certain embodiments, for example, the contact angle between the nanoengineered surface and the liquid medium, when the nanoengineered surface is non-wetting with respect to the liquid medium, is greater than 90°, greater than or equal to 95°, greater than or equal to 100°, greater than or equal to 105°, greater than or equal to 110°, greater than or equal to 115°, greater than or equal to 120°, greater than or equal to 125°, greater than or equal to 130°, greater than or equal to 135°, greater than or equal to 140°, greater than or equal to 145°, greater than or equal to 150°, greater than or equal to 155°, greater than or equal to 160°, greater than or equal to 165°, greater than or equal to 170°, or greater than or equal to 175°. In some embodiments, the contact angle between the nanoengineered surface and the liquid medium, when the nanoengineered surface is non-wetting with respect to the liquid medium, is less than or equal to 180°, less than or equal to 175°, less than or equal to 170°, less than or equal to 165°, less than or equal to 160°, less than or equal to 155°, less than or equal to 150°, less than or equal to 145°, less than or equal to 140°, less than or equal to 135°, less than or equal to 130°, less than or equal to 125°, less than or equal to 120°, less than or equal to 115°, less than or equal to 110°, less than or equal to 105°, or less than or equal to 100°. Combinations of the above recited ranges are possible (e.g., the contact angle between the nanoengineered surface and the liquid medium, when the nanoengineered surface is non-wetting with respect to the liquid medium, is greater than or equal to 90° and less than or equal to 180°, the contact angle between the nanoengineered surface and the liquid medium, when the nanoengineered surface is non-wetting with respect to the liquid medium, is greater than or equal to 130° and less than or equal to) 140°. Other ranges are also possible. The contact angle between the nanoengineered surface and the liquid medium can fall within any of these ranges, for example, when the droplet of the liquid medium and the nanoengineered surface are present at conditions at which the method is performed (e.g., during use).

In accordance with certain embodiments, at least a portion of the nanoengineered surface may be functionalized with one or more non-polar functional groups. According to certain embodiments, for example, at least a portion of the nanoengineered surface is silanized. In some embodiments, at a least a portion of the nanoengineered surface comprises one or more organosilyl groups (e.g., an organic compound that includes a carbon-to-silicon bond) functionalized, bound to, and/or otherwise attached to at least the portion of the nanoengineered surface. Advantageously, silanization of the nanoengineered surface may render the nanoengineered surface hydrophobic, as explained in greater detail elsewhere herein. Without wishing to be bound by any particular theory, the silanized nanoengineered surface may have a higher degree of hydrophobicity as compared to a nanoengineered surface that is not silanized but is otherwise equivalent.

According to some embodiments, the nanoengineered surface may be at least partially hydrophobic when the liquid medium comprises an aqueous solution and/or a polar solvent. In certain embodiments, the nanoengineered surface may be at least partially hydrophilic and/or oleophobic when the liquid medium comprises a non-aqueous liquid, a non-polar solvent, or an oil.

As noted above, in some embodiments, the nanoengineered surface comprises a plurality of features. The features can include, according to certain embodiments, microscale features and/or nanoscale features. According to certain embodiments, the size of the features (e.g., the maximum height of the features), the shape of the features, and/or the characteristic spacing of the features on the nanoengineered surface may affect the hydrophobicity and/or hydrophilicity of the surface. In some embodiments, for example, the size, shape, and/or the characteristic spacing of the features on the nanoengineered surface may advantageously be configured such that the nanoengineered surface captures and spreads bubbles.

In certain embodiments, the features are dispersed on the nanoengineered surface in a random (e.g., fractal) or patterned manner. In some embodiments, the features comprise protrusions (e.g., nanoscale protrusions). Non-limiting examples of protrusions include spherical or hemispherical protrusions, such as ridges, pores, spikes, pillars, and posts. In certain embodiments, the features comprise microscale ridges, pores, spikes, pillars, and/or posts. In some embodiments, the features comprise nanoscale ridges, pores, spikes, pillars, and/or posts.

The features, in accordance with certain embodiments, may be introduced to the surface using a variety of suitable methods, including mechanical and/or chemical methods. For example, in some embodiments, the features can be introduced to the surface via lithography. In certain embodiments, the features can be introduced to the surface via self-assembly. In some embodiments, the features can be deposited onto a substrate. According to certain embodiments, the features can be etched into a substrate (e.g., using acid etching, base etching, and/or plasma etching). In certain embodiments, the features can be introduced to the surface via laser ablation. In some embodiments, the features can be sintered onto a substrate (e.g., via powder sintering). Certain embodiments comprise forming the features by inducing a phase change and/or crystallization. For example, in some embodiments, features are formed when a material is melted and/or dissolved and when the material solidifies again (e.g., during cooling and/or precipitation, for example, after solvent has evaporated) it forms solid features (e.g., in the form of crystals). These solid features can serve as the features described elsewhere herein.

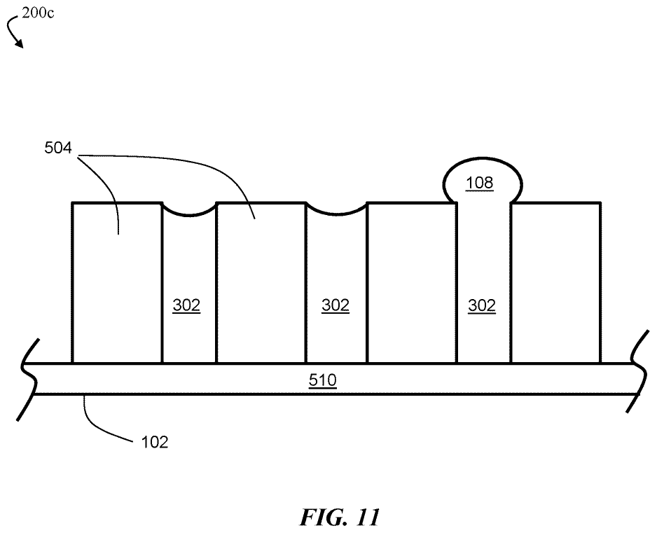

As noted above, according to certain embodiments wherein the nanoengineered surface comprises a plastron layer, trapped gas is positioned between the features on the nanoengineered surface. In some embodiments, the features form a textured surface comprising a matrix of solid features spaced sufficiently close to stably contain (e.g., trap) gas therebetween or therewithin. For example, FIG. 11 shows a cross-sectional schematic diagram illustrating the interaction of gas with trapped gas positioned between features on a nanoengineered surface, according to some embodiments. In FIG. 11, system 200c comprises nanoengineered surface 102 comprising a plurality of features 504. According to certain embodiments, features 504 are posts. Features 504 form, in accordance with certain embodiments, a textured surface comprising a matrix of solid features on substrate 510 that are sufficiently close and stably contain trapped gas (e.g., plastron layer 302) therebetween. According to some embodiments, as shown in FIG. 11 and as described elsewhere herein, gas 108 is transported to nanoengineered surface 102. In some embodiments, gas 108 merges with the trapped gas positioned between features 504 (e.g., plastron layer 302). Gas 108 can spread through and become part of plastron layer 302, in accordance with certain embodiments.

In some embodiments, the spacing between the features is selected such that the features are able to trap gas between the features. For example, referring to FIG. 5A, in some embodiments, spacing 512 between features 504c and 504d can be selected such that features 504c and 504d are able to trap gas between features 504c and 504d.

According to certain embodiments, the nanoengineered surface can be at least partially made up of microscale features. The term “microscale” is used herein in a manner consistent with its ordinary meaning in the art. Microscale features are features having a maximum height of from 1 micrometer to 100 micrometers. The maximum height generally refers to the longest dimension from the substrate on which the feature is positioned to the end of the feature opposite the substrate. As one illustrative example, referring to FIG. 5A, feature 504d has maximum height 514. According to some embodiments, the maximum height of the microscale features is from 1 micrometer to 10 micrometers, 10 micrometers to 20 micrometers, 20 micrometers to 30 micrometers, 30 micrometers to 50 micrometers, 50 micrometers to 70 micrometers, or 70 micrometers to 100 micrometers. Combinations of the above cited ranges are also possible (e.g., 30 micrometers to 70 micrometers, or 20 micrometers to 100 micrometers). Other ranges are also possible. The maximum height of the microscale features may be determined by electron microscopy techniques (e.g., scanning electron microscopy and/or transmission electron microscopy).

In certain embodiments, the nanoengineered surface can be at least partially made up of nanoscale features. The term “nanoscale” is used herein in a manner consistent with its ordinary meaning in the art. Nanoscale features are features from 1 nm to 1 micrometer in maximum height. According to some embodiments, the maximum height of the nanoscale features is from 1 nm to 100 nm, 100 nm to 200 nm, 200 nm to 300 nm, 300 nm to 500 nm, 500 nm to 700 nm, or 700 nm to 1 micrometer. Combinations of the above recited ranges are possible (e.g., 300 nm to 700 nm, or 200 nm to 1 micrometer). Other ranges are also possible. The maximum height of the nanoscale features may be determined by electron microscopy techniques (e.g., scanning electron microscopy and/or transmission electron microscopy).

According to some embodiments, the features on the nanoengineered surface can include a combination of features of different maximum heights. According to some embodiments, for example, the nanoengineered surface comprises both microscale and nanoscale features.

According to certain embodiments, the features may have any of a variety of suitable characteristic spacings. As used herein, the characteristic spacing of a particular feature refers to the shortest distance between the external surface of the feature and the external surface of that feature's nearest neighbor. For example, referring to FIG. 5A, the characteristic spacing of feature 504d is 512, the shortest distance between the external surface of feature 504d and the external surface of feature 504c. For a plurality of features, the average characteristic spacing refers to the number average of the characteristic spacings of the individual features.

According to some embodiments, the average characteristic spacing between the features, when present, is at least 1 nm, at least 10 nm, at least 50 nm, at least 100 nm, at least 200 nm, at least 300 nm, at least 500 nm, or at least 700 nm. According to some embodiments, the average characteristic spacing between the features, when present, is less than or equal to 1 micrometer, less than or equal to 700 nm, less than or equal to 500 nm, less than or equal to 300 nm, less than or equal to 200 nm, less than or equal to 100 nm, less than or equal to 50 nm, or less than or equal to 10 nm. Combinations of the above recited ranges are possible (e.g., from 1 nm to 100 nm, from 100 nm to 200 nm, from 200 nm to 300 nm, from 300 nm to 500 nm, from 500 nm to 700 nm, or from 700 nm to 1 micrometer). Other ranges are also possible.

According to certain embodiments, the features may be relatively regularly spaced across the nanoengineered surface. This may be achieved, for example, by spacing the features in a pattern. In some embodiments, the standard deviation of the nearest neighbor distances of the features on the nanoengineered surface is less than 20% (or less than 10%, or less than 5%, or less than 2%, or less than 1%) of the number average of the nearest neighbor distances of the features on the nanoengineered surface. This standard deviation can be determined by determining, for each feature, the nearest neighbor distance and comparing the standard deviation of those nearest neighbor distances to the number average of those nearest neighbor distances.

In some embodiments, the features of the nanoengineered surface define at least one member selected from the group consisting of pores, cavities, wells, interconnected pores, and interconnected cavities.

As noted above, the nanoengineered surface may be fully submerged in the liquid medium, in some embodiments. The term “fully submerged” is used to refer to a nanoengineered surface that is completely and not partially submerged in the liquid medium. In other embodiments, the nanoengineered surface may be partially submerged in the liquid medium. The term “partially submerged” is used to refer to a nanoengineered surface that is partially but not completely submerged in the liquid medium.

In some embodiments, the nanoengineered surface is submerged in the liquid medium at a particular tilt angle. The “tilt angle,” as used herein, refers to the angle between the submerged nanoengineered surface and an interface between the liquid medium and the environment outside the liquid medium. For example, referring to FIGS. 8A-8B, nanoengineered surface 102 is partially submerged in liquid medium 104 at tilt angle 603 (i.e., the angle that nanoengineered surface 102 makes with the interface between liquid medium 104 and the environment outside liquid medium 104). Advantageously, adjusting the tilt angle of the submerged nanoengineered surface can, according to certain embodiments, control the rate at which bubbles interact with, are captured by, and/or spread on the nanoengineered surface. In certain embodiments, the nanoengineered surface is submerged in the liquid medium at a title angle of 0° to 10°, 10° to 15°, 15° to 20°, 20° to 30°, 30° to 40°, 40° to 50°, 50° to 60°, 60° to 70°, or 80° to 90°. Combinations of the above recited ranges are possible (e.g., a tilt angle of 0° to 90°, 20° to 50°, or 50° to) 90°. Other ranges are also possible.

The nanoengineered surface may comprise any of a variety of suitable materials. In some embodiments, at least a portion of the nanoengineered surface comprises a non-polar material. According to some embodiments, at least a portion of the nanoengineered surface (e.g., at least 10%, at least 25%, at least 50%, at least 75%, at least 90%, or at least 99% of the surface area of the nanoengineered surface) comprises a polymer (e.g., a non-polar polymer). In certain embodiments, at least a portion of the polymer is fluorinated (e.g., a fluoropolymer). In some embodiments, for example, the nanoengineered surface comprises a polymeric fluorocarbon. In certain non-limiting embodiments, the nanoengineered surface comprises polytetrafluoroethylene. Other materials are also possible.

In certain embodiments, the nanoengineered surface comprises a substrate and features (e.g., microscale features and/or nanoscale features). Referring, for example, to FIGS. 5A-5C, nanoengineered surface 102 comprises substrate 510 and features 504. In some embodiments, the substrate and the features are made of the same material. For example, in some embodiments, the features can be formed by etching portions of the substrate to leave behind non-etched substrate portions that form the features.

In some embodiments, the features are disposed on a substrate having a first surface and a second surface substantially opposite the first surface. Referring, for example, to FIG. 5A, features 504 are disposed on substrate 510 having first surface 604 and second surface 605 substantially opposite first surface 604. In certain embodiments, as shown in FIG. 5A, the features are disposed on the second surface of the substrate that is substantially opposite the first surface. In other embodiments, although not shown in the figures, the features are disposed on both the first surface of the substrate and the second surface that is substantially opposite the first surface.

In some embodiments, the nanoengineered surface comprises chemically modified features, a coated surface, or a surface with a bonded monolayer.

The nanoengineered surface can have a variety of suitable geometric surface areas. The term “geometric surface area” refers to the area that would be measured macroscopically (for example, without counting contributions from pores, microscale or nanoscale features, small-scale roughness, etc.) and can generally be understood as the total projected area. According to certain embodiments, the nanoengineered surface has a geometric surface area of at least 0.1 cm², at least 1 cm², at least 10 cm², at least 100 cm², at least 1000 cm², at least 10,000 cm², at least 100,000 cm², or at least 1,000,000 cm².

According to certain embodiments, the features of the nanoengineered surface are distributed over a geometric surface area of at least 0.1 cm², at least 1 cm², at least 10 cm², at least 100 cm², at least 1000 cm², or at least 10,000 cm².

In accordance with some embodiments, at least 10%, at least 25%, at least 50%, at least 75%, at least 90%, at least 99%, or 100% of the geometric surface area of the nanoengineered surface is submerged in the liquid medium.

In accordance with some embodiments, at least 10%, at least 25%, at least 50%, at least 75%, at least 90%, at least 99%, or 100% of the geometric surface area over which the features are distributed is submerged into the liquid medium.

According to certain embodiments, the features are distributed over the substrate such that the features occupy a particular solid fraction of the nanoengineered surface. The term “solid fraction” (also referred to as φ), as used herein, refers to the area fraction of the substrate that would be in direct contact with the liquid medium when the nanoengineered surface is submerged in the liquid medium. The solid fraction can be calculated by dividing the areas of the tops of the features that would be in contact with the liquid medium by the geometric surface area over which those features are distributed. Referring, for example, to FIG. 5B, each of features 504 have identical side lengths a and identical nearest neighbor spacings b. Accordingly, the nanoengineered surface solid fraction (φ) occupied by the features in FIG. 5B would be calculated as follows:

$$ϕ = {a}^{2} / {( a + b )}^{2}$$

In some embodiments, the nanoengineered surface has a surface fraction of greater than or equal to 0.1, greater than or equal to 0.2, greater than or equal to 0.3, greater than or equal to 0.4, greater than or equal to 0.5, greater than or equal to 0.6, greater than or equal to 0.7, or greater than or equal to 0.8. In certain embodiments, the nanoengineered surface has a surface fraction of less than or equal to 0.9, less than or equal to 0.8, less than or equal to 0.7, less than or equal to 0.6, less than or equal to 0.5, less than or equal to 0.4, less than or equal to 0.3, or less than or equal to 0.2. Combinations of the above recited ranges are possible (e.g., the nanoengineered surface has a surface fraction of greater than or equal to 0.1 and less than or equal to 0.9, the nanoengineered surface has a surface fraction of greater than or equal to 0.4 and less than or equal to 0.6). Other ranges are also possible.

In some embodiments, the nanoengineered surface comprising the features has any suitable surface roughness. The surface roughness is defined as the total surface area of the nanoengineered surface (including features, holes, etc.) divided by the geometric surface area of the nanoengineered surface. Thus, for the case of regularly-distributed square posts (as shown in FIG. 5C) the surface roughness would be:

$$r = 1 + 4 ah / {( a + b )}^{2}$$

where h is the height of the post.

In some embodiments, the nanoengineered surface has a surface roughness of greater than 1, greater than or equal to 2, greater than or equal to 3, greater than or equal to 4, greater than or equal to 5, greater than or equal to 6, greater than or equal to 7, greater than or equal to 8, or greater than or equal to 9. In certain embodiments, the nanoengineered surface has a surface roughness of less than or equal to 10, less than or equal to 9, less than or equal to 8, less than or equal to 7, less than or equal to 6, less than or equal to 5, less than or equal to 4, less than or equal to 3, or less than or equal to 2. Combinations of the above recited ranges are possible (e.g., the nanoengineered surface has a surface roughness of greater than 1 and less than or equal to 10, the nanoengineered surface has a surface roughness of greater than or equal to 4 and less than or equal to 6). Other ranges are also possible.

According to certain embodiments, the nanoengineered surface is configured such that the nanoengineered surface and the liquid medium satisfy the following relationship:

$$\frac{( 1 - ϕ )}{( r - ϕ )} < - cos θ$$

wherein φ is the solid fraction of the nanoengineered surface, r is the surface roughness of the nanoengineered surface, and θ is the contact angle that would be made between a hypothetical surface without features and a droplet of the liquid medium. According to certain embodiments, the above relationship is the condition for a hydrophobic nanoengineered surface to sustain a plastron layer when submerged into a liquid medium.

The liquid medium may have any of a variety of suitable compositions. As noted above, for example, the liquid medium may comprise an aqueous solution and/or a polar solvent, in some embodiments. Other liquid mediums are also possible. In certain embodiments, for example, the liquid medium comprises a non-aqueous liquid, a non-polar solvent, and/or an oil.

According to certain embodiments, the liquid medium is configured to absorb one or more gases. In some embodiments, for example, the liquid medium is configured to absorb CO₂, O₂, O₃, N₂, H₂, a NOₓ, SO₂, CO, and/or combinations thereof. The liquid medium may absorb the one or more gases until the concentration of the one or more gases reaches saturation and/or supersaturation.

In certain embodiments, the liquid medium comprises one or more components that are configured to react with a gas (e.g., CO₂). In certain embodiments, for example, the liquid medium comprises a hydroxide (e.g., an aqueous hydroxide solution). The hydroxide may, in certain embodiments, be configured to react with CO₂.

In some embodiments, the liquid medium comprises an aqueous solution of an alkali hydroxide. For example, in certain embodiments, the liquid medium comprises an aqueous solution of LiOH, NaOH, KOH, RbOH, CsOH, and/or combinations thereof. In certain embodiments, the liquid medium comprises an aqueous solution of an alkaline earth hydroxide. In some embodiments, for example, the liquid medium comprises an aqueous solution of Ca(OH)₂, Sr(OH)₂, Ba(OH)₂, and/or combinations thereof. Combinations of alkali hydroxides and alkaline earth hydroxides are also possible. Other hydroxide salts are also possible.

The concentration of the one or more components within the liquid medium may be any of a variety of suitable values. In some embodiments, for example, the concentration of the one or more components within the liquid medium is greater than or equal to 0.01 M, greater than or equal to 0.05 M, greater than or equal to 0.1 M, greater than or equal to 0.5 M, greater than or equal to 1 M, or greater than or equal to 5 M. In certain embodiments, the concentration of the one or more components within the liquid medium is less than or equal to 10 M, less than or equal to 5 M, less than or equal to 1 M, less than or equal to 0.5 M, less than or equal to 0.1 M, or less than or equal to 0.05 M. Combinations of the above recited ranges are possible (e.g., the concentration of the one or more components within the liquid medium is greater than or equal to 0.01 M and less than or equal to 10 M, the concentration of the one or more components within the liquid medium is greater than or equal to 0.5 M and less than or equal to 1 M). Other ranges are also possible.

According to certain embodiments, the liquid medium is contained within a container. As shown in FIGS. 1A-4 and 8A-9B, for example, liquid medium 104 is contained within container 106. The container may be any of a variety of suitable containers. In some embodiments, for example, the container is a reactor, a bioreactor, a fluidic conduit, or the like. According to certain embodiments, the container is an absorber unit. For example, in some embodiments, the container is a packed tower absorber, a spray column absorber, a bubble column absorber, or the like.

The source of gas may be any of a variety of suitable sources of gas. In some embodiments, for example, the source of gas comprises a needle, a sparger, a conduit, or the like. In certain embodiments, injecting the gas comprises injecting the gas through a needle. Referring, for example, to FIGS. 1B and 3B, source of gas 110 may be a needle, and injecting gas 108 comprises injecting gas 108 through a needle. In other embodiments, injecting the gas comprises injecting the gas through a sparger. For example, referring to FIGS. 1B and 3B, source of gas 110 may be a sparger, and injecting gas 108 comprises injecting gas 108 through a sparger.

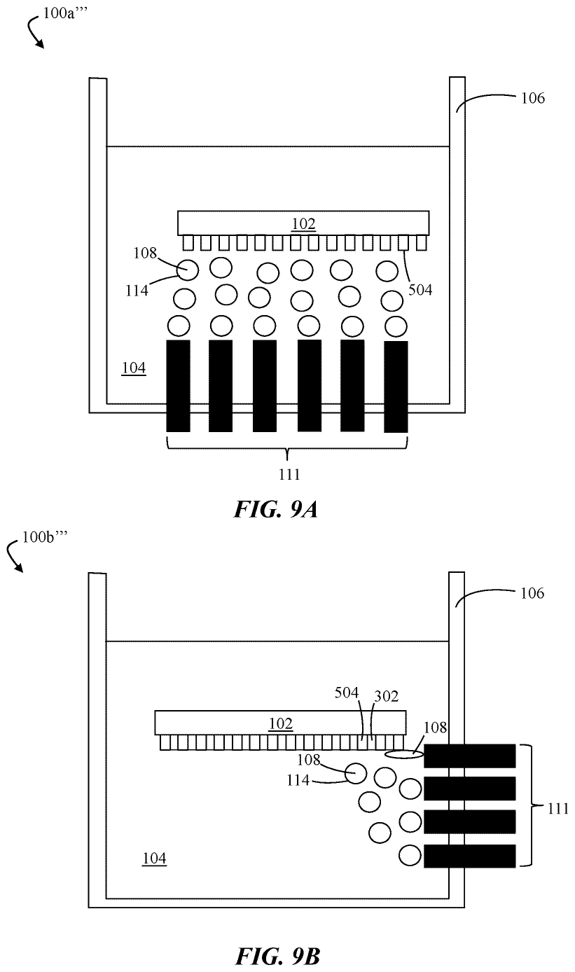

According to certain embodiments, injecting the gas comprises injecting the gas through a multiplicity of sources of gas. FIG. 9A shows, in accordance with certain embodiments, a cross-sectional schematic diagram representing method 100a′″ comprising injecting gas 108 at or near engineered surface 102, wherein gas 108 is injected through multiplicity of sources of gas 111. FIG. 9B shows, in accordance with certain embodiments, a cross-sectional schematic diagram representing method 100b′″ comprising injecting gas 108 at or near nanoengineered surface 102 associated with plastron layer 302, wherein gas 108 is injected through multiplicity of sources of gas 111. As described above, the sources of gas may, in some embodiments, comprise a needle, a sparger, a conduit, or the like. In certain embodiments, for example, injecting the gas comprises injecting the gas through a multiplicity of needles (e.g., an array of needles). Referring, for example, to FIGS. 9A-9B, sources of gas 111 may be needles, and injecting gas 108 comprises injecting gas 108 through a multiplicity of needles. In other embodiments, injecting the gas comprises injecting the gas through a multiplicity of spargers (e.g., an array of spargers). For example, referring to FIGS. 9A-9B, sources of gas 111 may be spargers, and injecting gas 18 comprises injecting gas 108 through a multiplicity of spargers.

The gas may be injected at any of a variety of suitable flow rates. In some embodiments, for example, injecting the gas comprises injecting the gas at a flow rate greater than or equal to 10 microliters per second, greater than or equal to 50 microliters per second, greater than or equal to 100 microliters per second, greater than or equal to 500 microliters per second, greater than or equal to 1 milliliter per second, or greater than or equal to 5 milliliters per second. In certain embodiments, injecting the gas comprises injecting the gas at a flow rate less than or equal to 10 milliliters per second, less than or equal to 5 milliliters per second, less than or equal to 1 milliliter per second, less than or equal to 500 microliters per second, less than or equal to 100 microliters per second, or less than or equal to 50 microliters per second. Combinations of the above recited ranges are possible (e.g., injecting the gas comprises injecting the gas at a flow rate greater than or equal to 10 microliters per second and less than or equal to 10 milliliters per second, injecting the gas comprises injecting the gas a flow rate greater than or equal to 500 microliters per second and less than or equal to 1 milliliter per second). Other ranges are also possible. The flow rate of the injected gas may be determined using a flow meter.

According to certain embodiments, the system may be configured such that the flow rate of the gas may be substantially similar to the rate of dissolution of the gas and/or the rate of reaction of the gas. Configuring the system in this way advantageously allows the nanoengineered surface to continuously enhance dissolution of the gas into the liquid media and/or reaction of the gas with one or more components within the liquid media over time. In certain embodiments, for example, the value of the flow rate of the gas may be within 20%, within 10%, within 5%, or within 2% of the value of the rate of dissolution of the gas and/or the rate of reaction of the gas.

The articles, systems, and methods described herein can generally be used in any of a variety of suitable applications. According to some embodiments, the articles, systems, and methods described herein can be used for gas absorption within an absorber unit, such as, for example, a packed tower absorber, a spray column absorber, a bubble column absorber, or the like. In certain embodiments, the absorber unit may be configured to absorb gas (e.g., CO₂) from an exhaust stream (e.g., flue gas) of an industrial process, such as an exhaust stream of a power plant or an internal combustion engine. In some embodiments, the absorber unit may have one or more fluidic connections to the exhaust stream. For example, in some embodiments, the system comprises a source of gas, as explained herein in greater detail, that is fluidically connected to one or more exhaust streams.

U.S. Provisional Patent Application No. 62/608,394, filed Dec. 20, 2017, and entitled “Foam Reduction and/or Prevention Methods and Associated Systems and Articles,” and International Patent Application No. PCT/US2018/066689, filed Dec. 18, 2018, and entitled “Foam Reduction and/or Prevention Methods and Associated Systems and Articles”, are incorporated herein by reference in their entirety for all purposes. U.S. Provisional Patent Application No. 63/381,285, filed Oct. 27, 2022, and entitled “Direct Injection of Gas into Engineered Capture Surfaces for Enhanced Absorption” is also incorporated herein by reference in its entirety for all purposes.

The following example is intended to illustrate certain embodiments of the present invention, but does not exemplify the full scope of the invention.

### Example

Absorption of gas into aqueous media has a multitude of important industrial applications. The most common method for absorption of gas into aqueous media is by using an absorber, which is a common chemical engineering unit operation for separations. Absorbers include common gas/liquid contactor varieties including packed towers, spray column and bubble column varieties, among others. These absorption approaches aim to maximize the interaction between the gas and liquid phases to promote improved mass transport. These approaches, like using absorption towers, are especially common for the removal of potentially hazardous gases from being released into the atmosphere during industrial activities. For example, packed tower absorbers are used for a variety of chemical scrubber applications, like in NO_{λ} removal and in the absorption of carbon dioxide or ammonia gases. The details of operation for various modes of absorption units and their associated fundamentals and design parameters have been extensively studied previously.

In certain types of reactive absorber units, like in bubble column type absorbers, the gas phase exists primarily as discrete bubbles rather than a bulk gas phase contacting thin films of liquid absorbent. As a result, injection of bubbles directly into reactors that readily react with the surrounding liquid media is a common practice in a variety of industries to enhance mass transport between the gas and liquid phases. However, in certain applications, the formation of foams from the injection of bubbles can be disadvantageous and cause issues. For example, in the case of sparged gas to support the operation of bioreactors, foams can decrease reactor yield and can even cause cell death when bubbles rupture. The need to use spargers for aeration in fermenters and bioreactors is also of critical importance to the cultivation of bacteria and algae for a variety of bioreactor types, including photobioreactors and miniature bioreactors. As a result, helping to mitigate the generation of foams using defoamer additives to limit these negative impacts is a multi-billion-dollar market that continues to grow. In addition, sparging gas for dissolution into liquid is a widespread and important processing step for activities in the food industry, like in the aeration of beverages, and as a pre-processing step in water treatment using injected bubbles to aid in removal of solid particulate and oils as well as antifouling of membranes in submerged anaerobic membrane reactors (SAMBRs) for sewage treatment.

Due to the intense current focus for scientists and engineers around the world to develop technologies to mitigate climate change and provide sustainable energy solutions, the absorption of carbon dioxide (CO₂) has become a particularly important system to study due to carbon dioxide's central role in global climate change and future sustainability considerations. As a result, the model system studied in this work is the absorption of CO₂ gas in an alkaline aqueous solution of potassium hydroxide of moderate ionic strength. The absorption of CO₂ bubbles in various alkaline solutions has been extensively studied previously, which provides useful references for physical constants and prior experimental results with which to make comparisons. Additionally, the capture, conversion and storage/utilization of carbon dioxide is a key challenge of the present, with a multitude of approaches being proposed. Traditional means of chemical absorption and physical adsorption are common routes for the separation of CO₂ from both dilute and higher concentration streams. More recently, novel and promising electrochemical methods for carbon dioxide separations have also been demonstrated.

From a carbon storage perspective, CO₂ mineralization efforts span a wide range of methods and applications including CO₂ mineralization using waste streams, saline sources like ocean water, and by injection of CO₂ into geologic formations. For example, the mineralization of CO₂ in geological formations is currently done at relatively large scales as in Sleipner Field off the coast of Norway in the North Sea, with ˜1 Mt of CO₂ injection annually, as well as in newer pilot scale facilities like the CarbFix project in Iceland. However, the processes associated with this type of underground storage occur over geological timescales, taking many years for the mineralization reaction to be completed to fix the carbon dioxide into a mineralized form. For example, recent results published by the CarbFix team report ˜200 tonnes of CO₂ injected at depth was almost completely mineralized after approximately 2 years. The wettability of the rock formations into which CO₂ is injected has critical implications in the permeability and mineralization dynamics, as well as the storage capacity when carbon is sequestered in this manner, like in deep saline aquifers. However, the wettability of the solid surface in contact with a gas targeted to be absorbed also has significant consequences in traditional absorbers as well, like packed tower absorbers. In these packed tower arrangements, the packing materials are typically coated to promote wetting of the liquid absorbent to create a continuous film, creating the interface which the target gas is absorbed on. However, the work presented here is interested in engineering surfaces that demonstrate advantageous benefits for spreading CO₂ gas bubbles into their textures to promote enhanced absorption into an alkaline media that is less wetting to the surface than the gas. In this way, capillary forces can be used advantageously to spread the bubble to be absorbed and enhance the mass transport between the gas and liquid phases relative to a bubble rising in the liquid media as is the case in a bubble column type absorber.

To realize this end, engineered superhydrophobic surfaces have been developed to spread bubbles and improve mass transport by advantageous geometric manipulation of bubbles via capillary forces. Prior work has rigorously analyzed the dynamics of spreading air bubbles' fundamentals, but these bubbles did not readily react with the surrounding liquid media. Additionally, work on bubble capture has utilized similar surfaces for the rapid spreading of bubbles into capture surfaces for the prevention of foam accumulation at free interfaces for industrial applications, which presents a method for the removal and mitigation of foam accumulation, but does not investigate a readily reacting gas/liquid system. It is not believed that any work has yet been shared which studies spreading bubbles on nanoengineered surfaces with a bubble that rapidly reacts with the surrounding liquid media. Here, a system which enhances the reaction rates of CO₂ relative to plain bubble reaction rates by spreading the gas into nanoengineered capture surfaces is presented. While the system presented here is motivated towards developing an absorber system which could be uniquely suited for small-scale and distributed CO₂ absorption applications for sustainability, the results are relevant for any gas/liquid absorption system and have general relevance for other chemical reactions for absorption.

### Measuring the Rate of CO₂ Bubble Absorption Experimentally

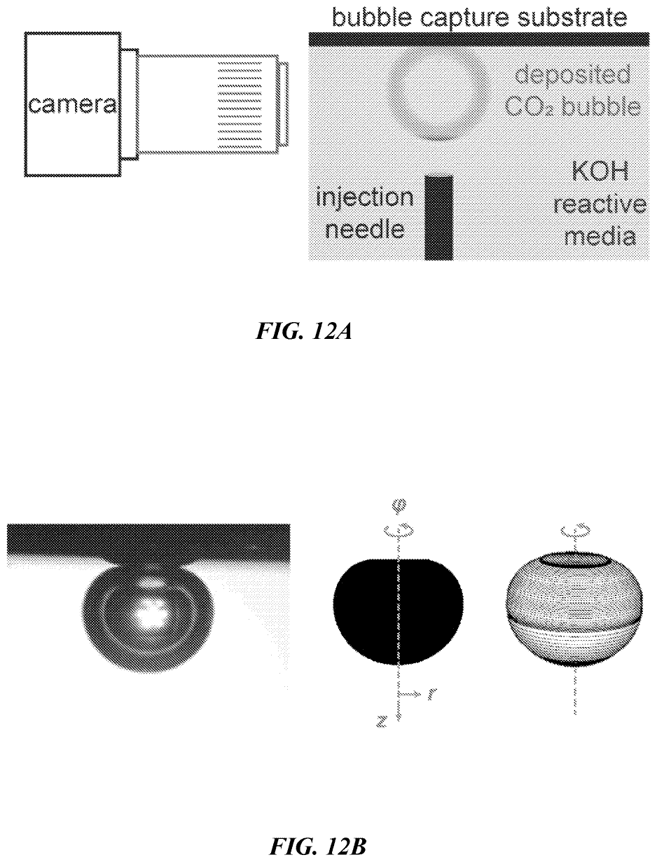

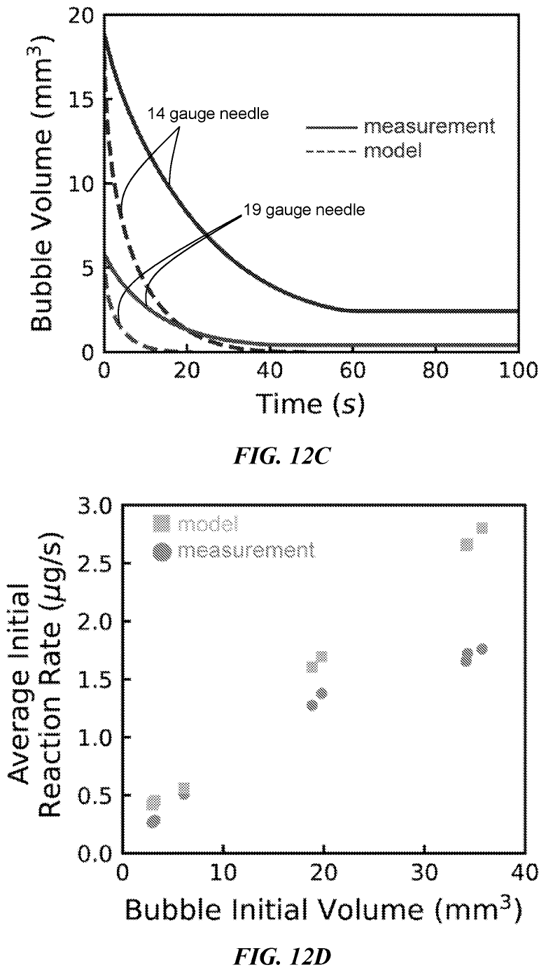

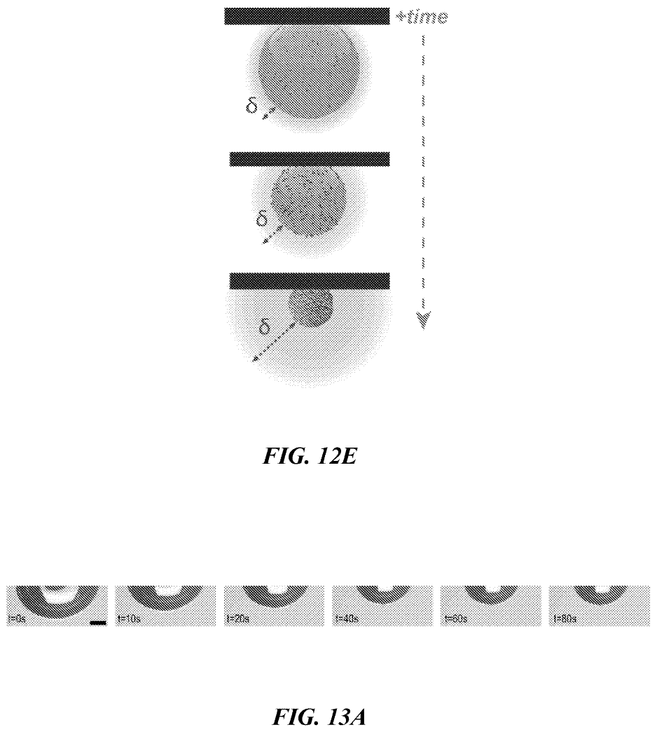

To measure the reaction rates for captured bubbles on capture surfaces to serve as a baseline to quantify the evolution of absorption of a gas bubble, a setup to image the captive bubbles from a side profile was developed (see FIG. 12A). Stainless steel dispensing needles were used to deliver single bubbles of pure CO₂ gas to the capture surface which was submerged in 0.1 M KOH. Additional information on the experimental setup and the single bubble delivery system are detailed in the Supporting Information herein. After bubbles were rapidly deposited onto the capture surface, videos of the evolution of their absorption were collected and image processing was used to extract the volume evolution of the bubbles during their reaction with KOH throughout the experiments, as shown graphically in FIG. 12B (see below for additional image processing detail). Resulting data was then analyzed to arrive at reaction rates for the CO₂ bubbles' absorption in the KOH solution.

As shown in FIG. 12C, the resulting data collected from the experiments shows two interesting features about the dissolution of captured bubbles on a hydrophilic capture surface where they remain relatively spherical in their shape throughout the absorption process. First, the reaction rates for bubbles drops off over time for both of the bubble sizes shown in FIG. 12C. Differently sized bubbles are achieved by changing the diameter of the dispensing needle used to deposit the bubble onto the capture surface. Second, after approximately 40 seconds for the smaller bubble (19 gauge needle), and approximately 60 seconds for the larger bubble (14 gauge needle), the bubbles' absorption stops and the size of the bubbles plateaus as the bubble size remains constant and absorption is halted. Both of these features, namely the decrease of flux over time and the plateauing behavior, have been reported previously and align with the observations made here. The decrease in the flux at the bubble's interface is a result of the development of the diffusion boundary layer, depicted graphically in FIG. 12E, as increasing in size over time, accordingly, decreasing the flux. The plateauing behavior of bubbles is most likely due to the aggregation of reaction products at the interface, also shown graphically in FIG. 12E. As the bubbles decrease in size, the interfacial area over which these particulates reside increases, and eventually their presence effectively passivates the interface from continuing to react. For much higher concentrations of hydroxide solutions, it has been previously observed that a visible and solid shell will rapidly form around the CO₂ gas bubble, also stopping the reaction from continuing. To capture the mass transport phenomena occurring for the idealized case of a spherical bubble of a certain volume being absorbed in a hydroxide solution, a numerical model was developed to compare against the experimental results captured for bubbles of various sizes deposited onto a smooth silicon substrate as an analog to a stagnant bubble being absorbed in solution. The details of this reaction-diffusion model are summarized in a subsequent section.

In FIG. 12D, the dotted traces correspond to the model's prediction of the evolution of gas absorption for the bubbles tested. First, the model predicts higher rates throughout the course of a bubble's absorption due to the simplification that the spherical bubble that is modeled does not have the capture surface impeding KOH access and limiting some portion of the bubble's surface area, so this difference is expected. Second, the model predicts that bubbles are completely absorbed by the hydroxide solution, which is also expected as the secondary aggregation of reaction products on the interface is not included in the model. However, the primary aim of the numerical model developed here is to accurately predict the order of magnitude of reaction rates for the bubbles being testing, since a goal of this example is to substantially decrease the timescale for these bubbles to be absorbed by engineering the capture surface to promote enhanced mass transport via spreading the gas into the superhydrophobic surface texture. For the larger bubble deposited in FIG. 12D of approximately 18 mm³ in initial volume, the predicted lifetime is approximately 45 seconds, while the smaller bubble of approximately 6 mm³ in initial volume takes approximately 20 seconds to be completely absorbed. The explicit goals of this example are twofold: (1) decreasing the timescale of absorption for CO₂ like these bubbles to the order of milliseconds rather than tens of seconds; and (2) enabling the complete absorption of these gas bubbles to avoid the plateauing behavior shown for these initial experiments. Next, the numerical model is discussed that allows for prediction and comparison with empirical results for the tested conditions for the remainder of experiments.

### Modeling the Rate of CO₂ Bubble Absorption Numerically

A reaction-diffusion numerical model was developed to predict the associated reaction rates and timescales for complete absorption of CO₂ spherical bubbles suspended on the capture surface in KOH solution, and to compare with the relatively spherical bubbles deposited onto hydrophilic surfaces, like those shown in FIG. 10B. In addition, the model will also aid in predicting the fully spreading bubble case for comparison which will be demonstrated in a later section. As previously discussed, the numerical model developed is focused on the prediction of the order of magnitude of reaction rates rather than having much higher degrees of accuracy and is also a tool to predict what should be expected from a spreading bubble system from an order of magnitude perspective.

For the modeled system of the chemical absorption, KOH and CO₂ undergo the following irreversible reaction, where k represents the reaction rate coefficient for the reaction:

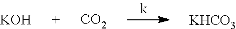

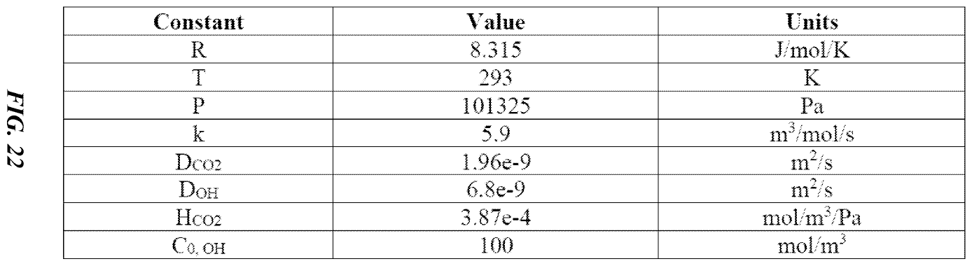

The equations of conservation of mass for OH and CO₂ dictate the behavior of the system. An immobile bubble boundary was assumed (the quasi-stationary assumption), eliminating the advective transport term of the conservation equations, thereby providing a reaction-diffusion system. As such, the system of two coupled partial differential equations solved numerically are:

$$\begin{matrix}\frac{\partial {c}_{{CO}_{2}}}{\partial t} = {D}_{{CO}_{2}} {∇}^{2} {c}_{{CO}_{2}} - {kc}_{{CO}_{2}} {c}_{{OH}^{-}} \\ \frac{\partial {c}_{{OH}^{-}}}{\partial t} = {D}_{{OH}^{-}} {∇}^{2} {c}_{{OH}^{-}} - {kc}_{{CO}_{2}} {c}_{{OH}^{-}}\end{matrix}$$

where c_{CO}_{₂} and c_{OH}_{^{−}} are the concentrations of the carbon dioxide gas and hydroxide ions present in the system, respectively, D_{CO}_{₂} and D_{OH}_{^{−}} are the diffusivities of carbon dioxide and hydroxide, respectively, k is the reaction rate coefficient, and t is time. This system was then solved using the appropriate boundary and initial conditions, which are summarized in FIG. 21. It is noted that c_{bulk, OH}_{^{−}}, which represents the bulk concentration of hydroxide ions, is 0.1 M in this example.

The system was solved using the MATLAB pdepe function in spherical and planar geometries for the non-spreading and spreading modeled cases, respectively. From the computed concentration profiles at each timestep, the CO₂ flux [mol/m²/s] at the surface was calculated and multiplied by the surface area of the bubble to obtain a CO₂ bubble dissolution rate at each timestep [mol/s]. The bubble volume and surface area at each timestep was continuously calculated using the current amount of CO₂ left in the bubble using the ideal gas law.

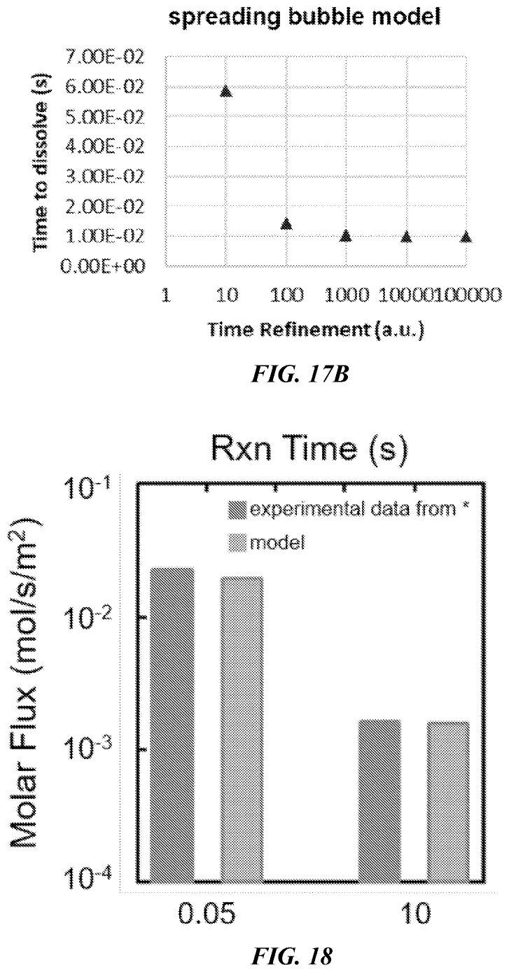

Convergence of bubble dissolution time via spatial and temporal mesh refinement was confirmed for both spherical and planar geometries (see FIGS. 16A-17B). Numerical CO₂ fluxes at times of 0.05 seconds and 10 seconds match literature values for the same times (see FIG. 18 for comparison). FIG. 22 shows a table of physical constants and material properties used in the numerical model. Additional details referenced previously can be found in the Supporting Information section regarding numerical modeling.

### Altering Surface Chemistry of Capture Surface to Enhance Absorption

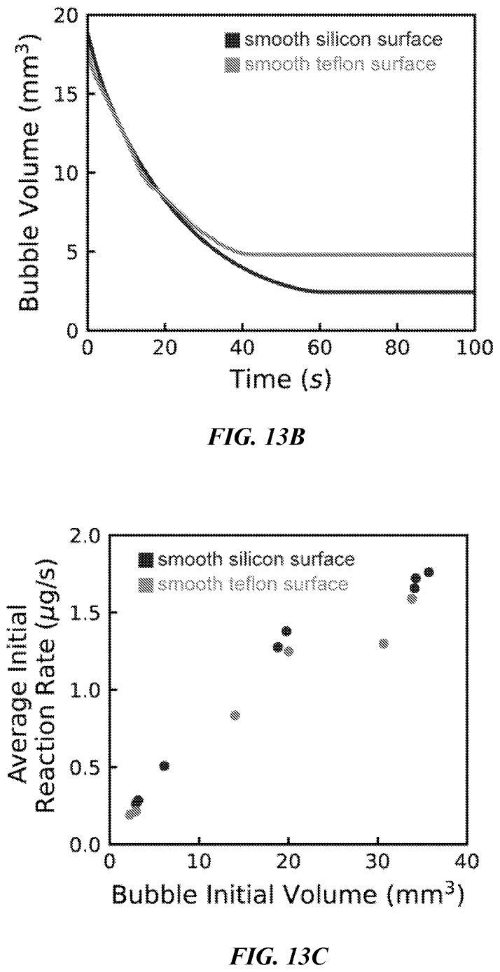

By altering the surface chemistry of the bubble capture surface, the wettability of the bubble on the capture surface can be changed, causing it to spread due to the hydrophobic nature of the polytetrafluoroethylene (PTFE), commonly referred to by its brand name Teflon®, on the smooth surface. As shown in FIG. 13A, the hydrophobic modification of a smooth surface with PTFE indeed causes the bubble to spread on the substrate. However, this manipulation of the geometry of the bubble is insufficient to noticeably impact the dynamics of the absorption of the bubble relative to that of a smooth hydrophilic surface, as shown in FIG. 13B. As shown, the decrease in the volume of gas over time is almost identical for a smooth silicon and smooth Teflon surface for the first 25 seconds of absorption. In addition, both the smooth hydrophilic and smooth hydrophobic surfaces show the plateauing effect of the CO₂ bubble stopping its absorption and remaining static while not reacting with the surrounding media. This similarity between the reaction rates of bubbles of various sizes being deposited on smooth capture surfaces that are hydrophilic silicon or hydrophobic Teflon® is summarized in FIG. 13C. As shown, a similar trend is observed that larger bubbles show a larger average reaction rate due to their larger surface areas, relative to smaller bubbles which react more slowly due to their smaller surface areas. These data highlight that having a roughened surface in addition to a sufficiently hydrophobic surface chemistry allows for complete spreading of a captured bubble, which has been reported previously in bubble capture studies. These results provided motivation to design and test a variety of micro- and nanotextured capture surfaces to determine an applicable capture surface that can enable rapid and complete spreading of the deposited CO₂ bubble on its surface.

### Nanoscale Superhydrophobic Surfaces to Rapidly Spread Gas Bubbles

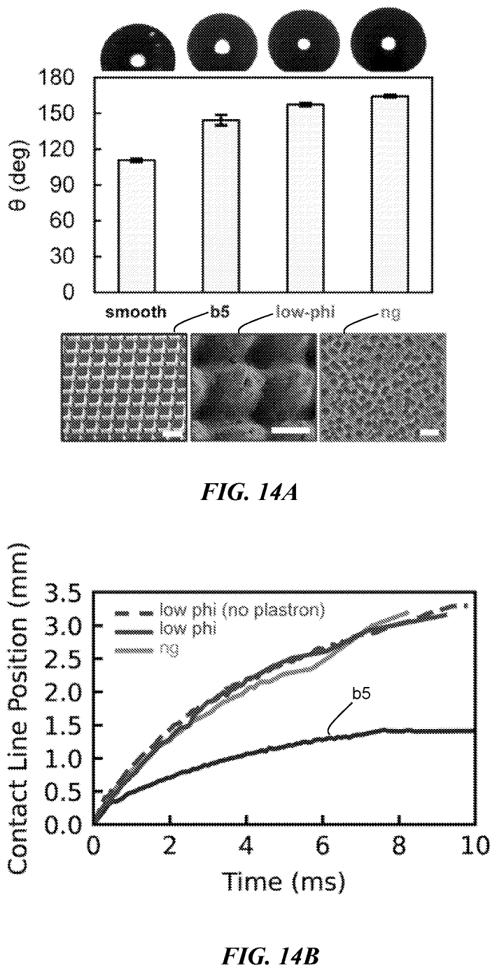

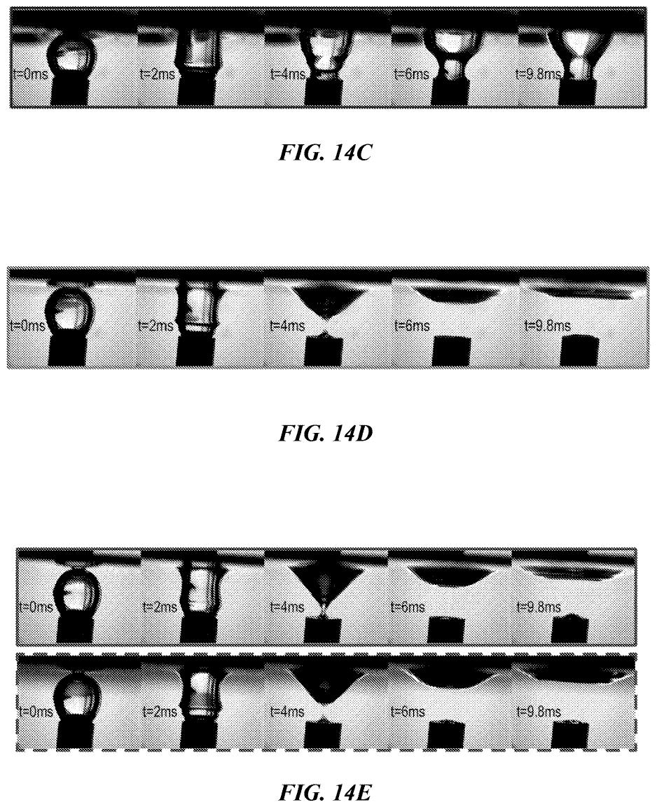

The addition of sufficient surface roughness to a surface with a hydrophobic surface chemistry can enable superhydrophobic surfaces with large equilibrium contact angles of 150° or more achieved in nature and in the lab. Three different textured surfaces were fabricated for testing their abilities to spread bubbles rapidly and completely as they were captured on the surface: (i) one surface with microscale roughness of a regularly spaced micropost array, designated as “b5”; (ii) a second with nanoscale roughness formed by reactive ion etching, designated as “ng” (nanograss); and (iii) a third with hierarchical micro/nanoscale roughness formed by laser ablation designated as “low-phi”, as shown in FIG. 14A. All three of these surfaces were textured into silicon wafers and subsequently silanized to impart a hydrophobic surface chemistry for the three textured surfaces. The fabrication of these surfaces is outlined in more detail in the Supporting Information herein. In FIG. 14A, the equilibrium contact angles are shown for these three silanized textured surfaces along with an untextured, smooth silanized silicon substrate for comparison to emphasize the enhancement achieved via texturing.

Next, experiments were carried out for non-reactive bubbles spreading into these fabricated textures to compare their ability to readily spread bubbles without including the reactivity of the bubbles at this point. These results are summarized in a series of time lapse photos taken from high-speed imagery of the capture and subsequent spreading of air bubbles in deionized water over the course of approximately 10 ms, shown in FIGS. 14C-14E. In FIG. 14C, it is shown that the microscale texture alone from the b5 texture, despite having a large equilibrium contact angle, is unable to completely spread the bubble. Instead, the bubble remains attached to the needle after the contact line is pinned to the surface and halts spreading approximately 8 ms after it is first captured by the surface. In contrast, both the purely nanoscale ng texture and the hierarchical micro/nanoscale low-phi texture are able to achieve complete spreading, removing the air bubble from the needle and spreading the gas continuously at a higher speed than the microscale b5 texture, as shown in FIG. 14D and FIG. 14E, respectively.

A final test was performed to ensure that the thermodynamically stable ‘plastron’ layer of trapped air on the surface of these superhydrophobic capture surfaces is not required to enable these advantageous spreading dynamics. During experiments with reacting gas bubbles, negative pressure was used to actively remove this plastron layer from capture surfaces prior to testing to enable the dissolution of the captured gas layer to be tracked visually, which would not be feasible practically if there is already a trapped layer of air on the surface prior to the reacting gas injection. To accomplish this, the spreading of an air bubble surrounded by deionized water using the hierarchical low-phi capture surface was similarly tested, but this time with the plastron layer removed from the surface prior to the test. The dynamics of bubble capture and spreading are effectively equivalent for the low-phi surface with and without the plastron layer, as shown in FIG. 14E, indicating that the presence of the plastron layer is not required to achieve the rapid and complete spreading that will be used to enhance absorption in a reactive bubble case.

From analyzing the images acquired during testing, the contact line of the advancing front of the captured air bubbles was tracked to measure their velocity and compare the dynamics between samples. As shown in FIG. 14B, all of the surfaces possessing nanoscale texture show very similar spreading dynamics, while the purely microtextured capture surface more slowly spreads the captured bubble, which also is pinned before completely spreading. Finally, from this data, the timescales for spreading for the bubbles were estimated from the velocity of the advancing contact line during spreading. The microscale b5 shows contact line instantaneous velocities up to 70 cm/s and an average contact line velocity of 17 cm/s ahead of being pinned. The ng and low-phi surfaces (with and without a plastron) show very similar spreading velocities to one another with instantaneous velocities of up to approximately 1.2 m/s and average velocities during the entire experiment of approximately 36 cm/s, approximately twice that of the microscale b5 texture.

From these contact line velocities of the ng and low-phi surfaces, the spreading timescale for these bubbles was estimated, which all lie somewhere between 1 and 10 ms. This agrees with a scaling argument balancing the hydrostatic pressure that drives the bubble into the texture against the inertia of the water that resists the spreading of the bubble. This balance causes the timescale for bubbles spreading in these cases to scale as

$${τ}_{spreading} \sim \frac{{a}^{2}}{{( g Ω )}^{1 / 2}} \sim 10 ms$$

where a is the capillary length (a≈2.5 mm for water), g is the gravitational constant, and Ω is the volume of the spreading bubble. This previously developed timescale agrees well with observed experimental results and with previously reported contact line velocities of ˜1 m/s for spreading air bubbles in water.

### Superhydrophobic Low-Phi Capture Surfaces for Rapid, Complete Absorption

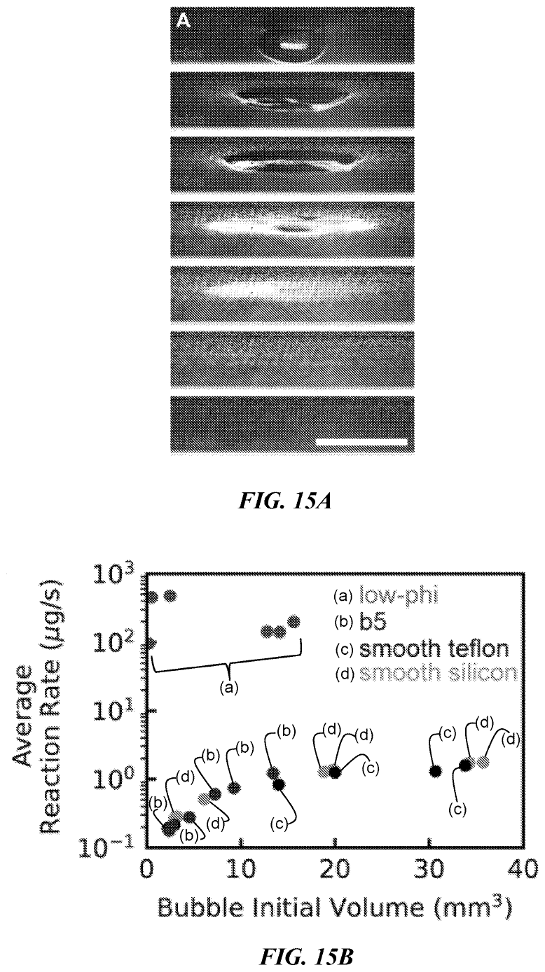

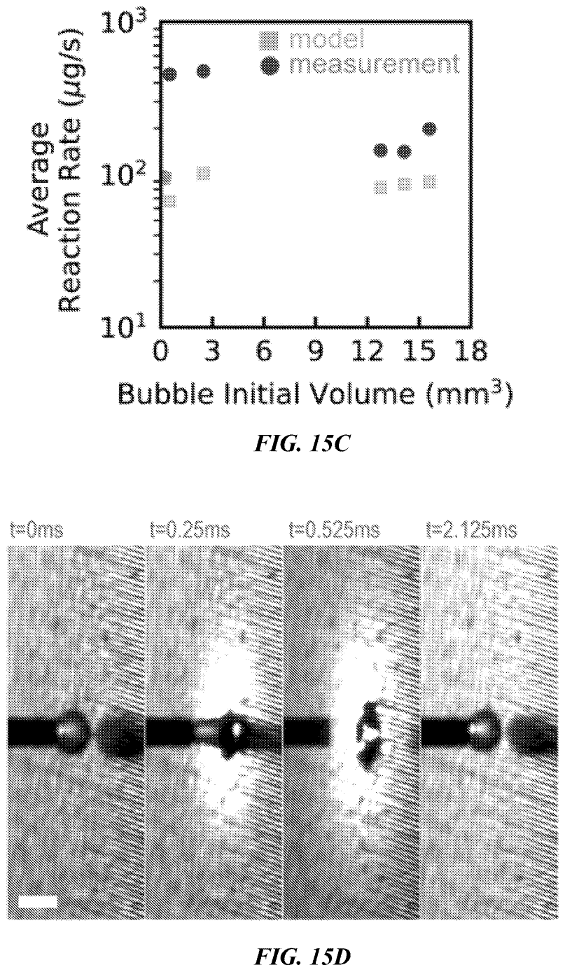

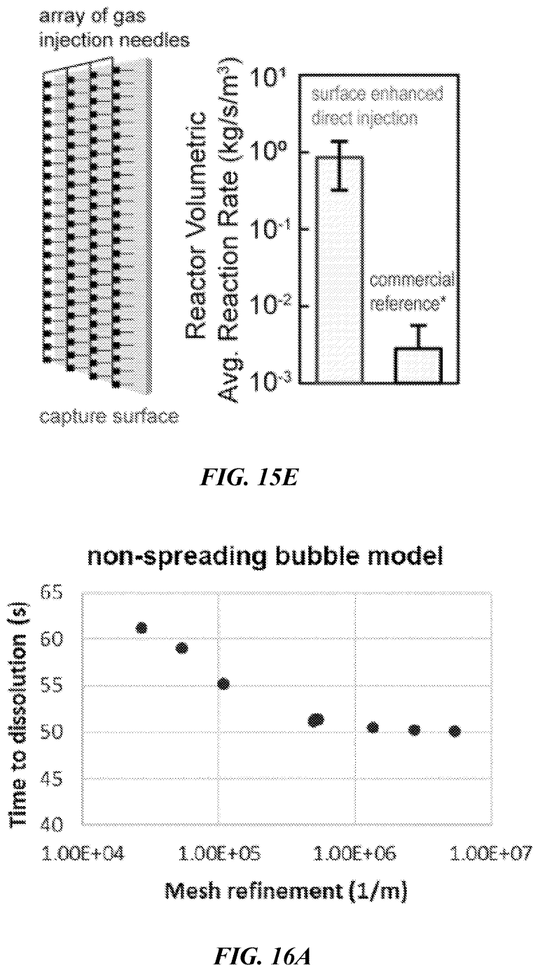

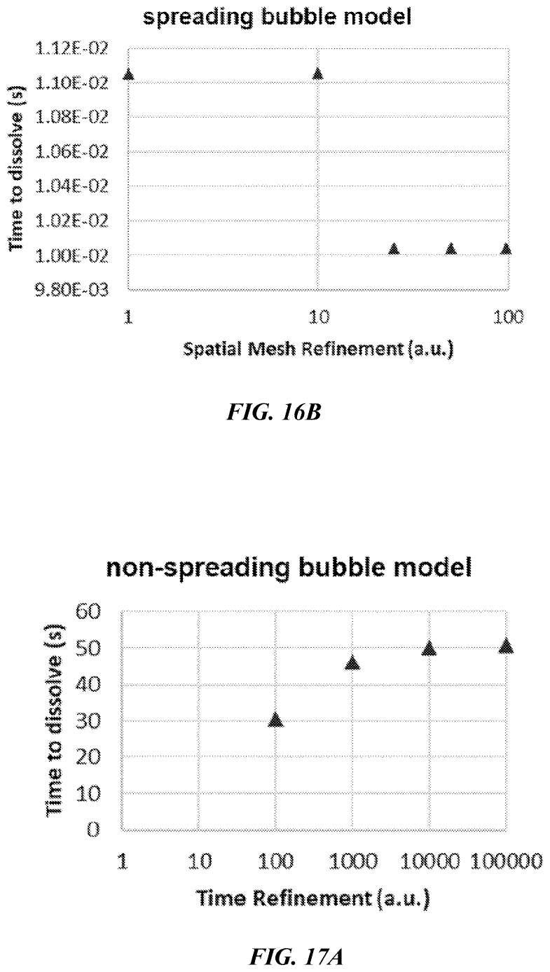

The capability for these nanoscale capture surfaces to enhance the absorption of CO₂ bubbles surrounded by a 0.1 M KOH absorption solution was also tested. Given the similar performance for both ng and low-phi, the decision to use the hierarchical low-phi surface for absorption testing was due to its facile nature to fabricate via laser ablation and its ability to hold significantly more gas within its deeper, hierarchical texture in comparison to the purely nanoscale ng surfaces. An illustrative test captured using high-speed imaging is shown in FIG. 15A (scale bar 5 mm). As shown, the CO₂ bubble is rapidly captured and fully spread over a timescale of ˜10 ms. Throughout the spreading, the CO₂ bubble is being absorbed as it reacts with the hydroxide solution to form potassium bicarbonate. Critically, the timescale over which the bubble has been entirely absorbed has been decreased from ˜10s of seconds for a similarly sized captive bubble case to plateau and cease absorption to ˜100 ms for the spreading case for complete absorption. As a result, the average reaction rate for these bubbles is approximately two orders of magnitude larger than the average reaction rates for the first 20 seconds for the captive bubbles tested for all of the non-nanoscale capture surfaces, as summarized in FIG. 15B. The increase in magnitude of the average reaction rate is well-captured by the developed model, which predicts this two order of magnitude increase relative to the non-spreading bubble case, as shown in FIG. 15C.

The first feature of spreading the CO₂ bubble which leads to enhancement in absorption of CO₂ is the matching of the timescales of spreading of the bubble with the timescale of the reaction taking place. The timescale for the reaction can be derived from the bulk concentration of reactant in solution and the reaction rate coefficient τᵣₓₙ˜(c_{hulk, OH}_{^{−}}k)⁻¹≈1.7 ms. When this is compared with the timescale of spreading introduced in the previous section, a modified Damköhler number, Da, is provided, representing a dimensionless number comparing the timescale of the bubble spreading against the timescale for the reaction to occur:

$$Da = \frac{{τ}_{spreading}}{{τ}_{rxn}}$$

In this scenario, by matching the order of the timescales of spreading and reaction to be between 1 and 10 ms, the spreading bubble allows CO₂ to be continuously supplied to a new interface of reacting gas and liquid absorbent which minimizes and resets the diffusion boundary layer. Minimizing the extent to which a boundary layer is maintained enables the reaction to persist at the highest rates while the bubble is spreading. Secondly, the nature of the spreading itself increases the surface area per volume of gas available for reaction relative to the spherical bubble case, which maintains a surface which is closer to the minimal area per volume. As shown in FIG. 15A, this enlarged surface area for interaction is maintained relatively constant after the bubble has spread into the texture. This is advantageous relative to the case of a bubble shrinking during absorption, which has its surface area decrease as the square of the radius of the bubble. Finally, the rapid nature of complete reaction of the CO₂ with the hydroxide also enables the bubble to be completely absorbed and not present the plateauing behavior which persisted for all of the non-spreading cases tested. The aggregation of product formation at the surface of the bubble interface will occur on a timescale that is slower than the reaction itself, allowing the spreading bubble to react quickly enough to avoid product aggregation and be completely absorbed.

Finally, there is an interesting reversal in the overall trend in the average rates of reaction and the initial bubble size between the bubble and spreading bubble cases. For all the non-spreading bubble capture surfaces tested, there is a general trend for larger bubbles to be absorbed at a larger rate driven by their larger available area to react in comparison to smaller bubbles, as shown in FIG. 15B. However, this tendency is reversed in the case of spreading bubble absorption as the bubbles with the highest rates tested tended to be the smallest. Since spreading has significantly enhanced the surface area of these smaller bubbles, the fact that there is a smaller volume of gas to react allows these bubbles to react quickly enough to minimize the impacts of diffusion boundary development relative to their larger spreading counterparts, allowing them to be absorbed extremely rapidly. For example, FIG. 15D shows a bubble with a radius of approximately 500 μm, which can be absorbed rapidly over the course of only a few milliseconds, having successive bubbles repeatedly injected over time at this rate.

The conceptual embodiment of an application for surface enhanced direct injection of gas for absorption is shown graphically in FIG. 15E (left). An array of small needles rapidly injecting gas bubbles into the capture surface spaced sufficiently apart such that neighboring needles' spreading bubbles do not interact to a significant degree. If a small-scale absorber of this type with a 20×20 array of injection needles (400 total needles) is envisioned, a total size of approximately 10 cm×10 cm×2.5 cm would be required. When the average rate for this type of an absorber is normalized by the volume the reactor actually takes up, a reactor volumetric average reaction rate of ˜1 kg/s/m³ is provided, as shown in FIG. 15E (right). For a commercial reference, the absorption tower of one of the largest post-combustion carbon capture projects in the world, Petra Nova, was used. This absorption tower absorbs CO₂ from the exhaust of a co-located coal-fired power plant near Houston, Texas in the United States with a capacity of 1.6 Mt CO₂ annually. As a result, Petra Nova's absorption tower represents the epitome of the advantages of scale that can be achieved when large-scale absorption towers are utilized for gas separations. However, it is generally difficult to scale down these types of technologies and they are therefore not well-suited for distributed or small-scale and modular absorption modes. Given the simple nature of the operation of the surface enhanced direct injection modality demonstrated here, some of the potential advantages of these types of systems provide motivation for distributed and small-scale, modular operations. The same volumetrically normalized average reaction rate for Petra Nova is approximately three orders of magnitude lower than that for the surface enhance direct injection embodiment envisioned here.

Of course, this comparison is merely to motivate the advantageous nature of a surface enhanced direct injection methodology to enable high performance absorbers that would work well at a small scale and is not a suggestion that these sorts of systems would replace existing large scale absorption tower system applications. In reality, the scenarios between the absorption demonstrated here using a pure CO₂ gas being absorbed by a moderately alkaline solution of KOH cannot be compared directly to the scenario at Petra Nova where a gas mixture is being treated with an amine-based absorber liquid at elevated temperature and pressure. However, it is worth highlighting the enhanced reaction rates achieved here using a relatively moderate alkalinity in having the KOH concentration of 0.1 M, which could be advantageous when compared with higher concentration absorber units which risk material corrosion and damage in much more alkaline environments, which require more strict material considerations. In the future, it will be of interest to extend the systems and tests demonstrated here to include multi-component gas mixtures, rather than a pure gas, to increase the application relevance to absorption units for industrial applications in separations and chemical scrubbing.

### Supporting Information: Ultra-Fast Bubble Absorption Supplemental Information

Materials: For all carbon dioxide absorption experiments, the following materials were used for reactants: 0.1 M KOH solution was made by mixing semiconductor grade (99.99% pure) potassium hydroxide pellets purchased from Sigma-Aldrich (Cat No: 306568) with ASTM Type I deionized water (18 MΩ-cm resistivity), pure carbon dioxide gas (99.995%) used for all experiments was purchased from Airgas (Cat No: CD PC200).

Bubble Image Segmentation & Analysis: The Fiji253 distribution of the image processing platform ImageJ was used for segmenting collected imaging data to arrive at binary segmented images of the bubbles from each analyzed frame. Briefly, a bounding box was drawn around the region of interest containing the full extent of the bubble to be segmented. Following this, the image area outside the relevant bounding box was cleared, and the image was binarized using ImageJ's Make Binary command, followed by the ImageJ's Fill Holes command. The resulting image was a binary image with the bubble representing the dark foreground and a white background surrounding the segmented bubble. These binary images were then processed using a MATLAB script to determine their volumes by assuming radial symmetry about the vertical midpoint of the captive bubble and revolving each radial row of radial pixels to achieve a volume. An ImageJ macro was recorded to make implementing this image processing workflow less time consuming, only requiring the bounding box location as an input and then being able to run on sequential images for a given sequence of data to collect time series trends for bubble volumes. Image processing was only utilized for analysis of non-spreading bubble imaging data.

Numerical Modeling: FIG. 22 includes additional reference information for physical constants and material properties used in modeling the results presented. FIG. 18 includes data to highlight the fidelity of the model from a comparison with prior literature. FIGS. 16A-17B show convergence study results for temporal and spatial meshing using MATLAB to accurately approximate spatial and temporal results.

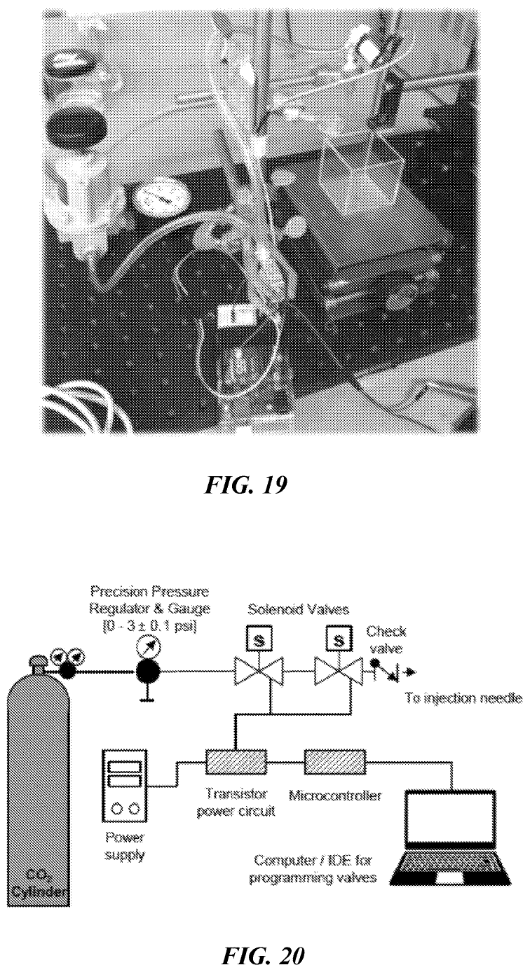

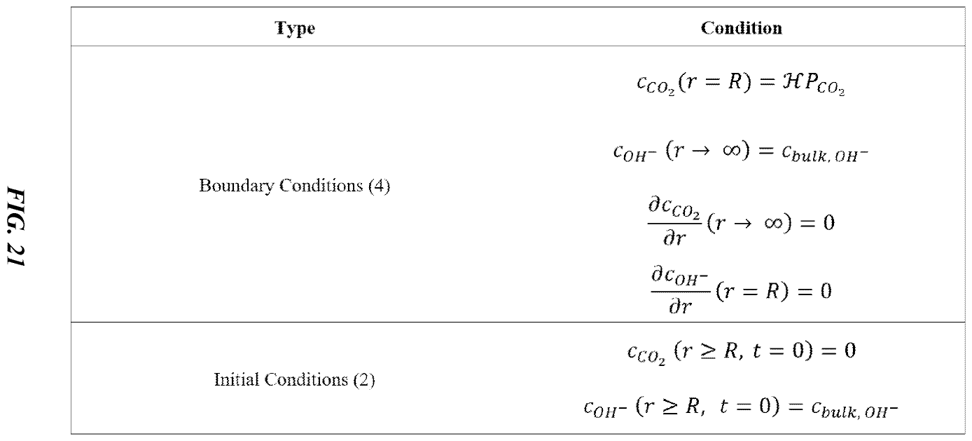

Experimental & Imaging Setup: Imaging data for non-spreading captive bubbles was collected at 30 frames per second as videos using a DSLR camera (Nikon D800) and high magnification lens (Navitar 12× Zoom). High-speed imaging data collected at higher frame rates was used to determine the average reaction rate for spreading bubbles, collected at 5,000 frames per second using a high-speed camera (Photron SA-1). For the embodiment shown of injection of the smallest bubbles tested, a higher frame of 40,000 frames per second was used to increase the temporal resolution of the data collection. FIG. 19 shows a photograph of the experimental setup used to capture bubbles on a capture surface and image from the side profile, and FIG. 20 shows a schematic diagram of the setup used to enable single bubble control via using pressure regulated gas flow of CO₂ and precisely timed actuation of solenoid valves via a microcontroller to deposit a single bubble CO₂ on-demand.

### Fabrication of Textured Capture Surfaces for Testing

Nanotexture, nanograss, “ng” capture surfaces were fabricated using a fluorine based reactive ion etching (RIE) process. Oxygen was introduced into the chamber during fluorine etching and caused the formation of oxide precipitates which were deposited and subsequently etched to create the relatively random nanoscale features that produce the nanotexture of the “nanograss” texture that is achieved.

Hierarchical “low-phi” capture surfaces were fabricated using a 1064 nm Nd:YAG laser (TYMKA Electrox) to ablate the surface of a polished silicon wafer. The ablation process was controlled to make a repeating raster pattern on the surface of the silicon which results in a hierarchical micro/nanotexture. The microscale pyramidal structures consisted of closely packed and reproducible pyramidal features spaced ˜75 μm apart and 75 μm from the spacing between the raster pattern of the laser on the surface. The nanoscale roughness was created through the thermal ablation process as the silicon is ablated from the surface, leaving a micro-/nanoscale hierarchical structure.

Microtextured “b5” capture surfaces were fabricated using a combination of photolithography and deep reactive ion etching processing (DRIE) to achieve a regular array of rectangular posts with a well-controlled spacing between them. In this case the microposts were 10 μm side lengths of the top square surface, 10 μm tall, and spaced 5 μm from adjacent microposts.

### CONCLUSION

In summary, the enhancement of CO₂ bubble absorption has been experimentally demonstrated and numerically modelled using advantageous surface interactions to spread the bubble into nanoengineered superhydrophobic bubble capture surfaces. By doing so, the average reaction rates for the CO₂ absorption process increase by more than two orders of magnitude in comparison to a non-spread bubble case. The importance of the presence of nanoscale surface roughness was demonstrated and surfaces capable of fully spreading CO₂ bubbles on a timescale commensurate with the absorption reaction timescale were shown. While non-spreading bubbles tend to show smaller reaction rates for smaller bubbles due to decreased surface area, spreading bubbles appear to invert this trend where the spreading smallest bubbles showed the largest average reaction rates for complete absorption due to their small volumes being spread to large surface areas. All spreading bubbles allowed for complete absorption of the gas to avoid the “plateauing” effect observed for all the non-spreading bubbles and blisters tested. Finally, direct injection of gas bubbles was envisioned as an advantageous method for absorption relative to large-scale absorption towers on a volumetric basis, which motivates this sort of motif for use in modular and distributed absorption applications, where centralized large-scale absorption methods cannot be practically or economically achievable.

It should be understood that the subject matter defined in the appended claims is not necessarily limited to the specific implementations described above. The specific implementations described above are disclosed as examples only. While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system, comprising:
a liquid medium;
a source of gas within and/or in fluidic communication with the liquid medium; and
a nanoengineered surface in contact with the liquid medium,
wherein the system is configured such that injected gas from the source of gas spreads on the nanoengineered surface such that the spread gas dissolves in the liquid medium and/or reacts with one or more components of the liquid medium.

2. The system of claim 1, wherein the nanoengineered surface is associated with a plastron layer, and the system is configured such that the injected gas from the source of gas spreads through the plastron layer such that the spread gas dissolves in the liquid medium and/or reacts with one or more components of the liquid medium.

3. The system of claim 1, wherein the source of gas comprises a needle or a multiplicity of needles.

4. The system of claim 1, wherein the source of gas comprises a sparger or a multiplicity of spargers.

5. The system of claim 1, wherein the injected gas comprises CO₂, O₂, O₃, N₂, H₂, NOₓ, SO₂, and/or CO.

6. (canceled)

7. A system, comprising:
a liquid medium;
a source of bubbles within and/or in fluidic communication with the liquid medium; and
a nanoengineered surface in contact with the liquid medium,
wherein the system is configured such that bubbles from the source of bubbles are captured by and spread on the nanoengineered surface such that the spread bubbles dissolve in the liquid medium and/or react with one or more components of the liquid medium.

8. The system of claim 7, wherein the source of bubbles comprises a needle or a multiplicity of needles.

9. The system of claim 7, wherein the source of bubbles comprises a sparger or a multiplicity of spargers.

10. The system of claim 7, wherein the bubbles comprise CO₂, O₂, O₃, N₂, H₂, NOₓ, SO₂, and/or CO.

11. (canceled)

12. The system of claim 1, wherein the liquid medium is contained within a container.

13. The system of claim 1, wherein the liquid medium is contained within a reactor.

14. The system of claim 1, wherein the liquid medium is contained within an absorber unit.

15. The system of claim 14, wherein the absorber unit is a packed tower absorber, a spray column absorber, or a bubble column absorber.

16. The system of claim 1, wherein the liquid medium comprises an aqueous solution.

17. The system of claim 1, wherein the liquid medium comprises a hydroxide (OH⁻).

18. The system of claim 1, wherein the liquid medium comprises aqueous NaOH and/or KOH.

19. The system of claim 1, wherein at least a portion of the surface comprises a nanoscale texture.

20-21. (canceled)

22. A method, comprising:
contacting a nanoengineered surface with a liquid medium; and
injecting a gas at or near the nanoengineered surface,
wherein the injected gas spreads on the nanoengineered surface, and
wherein the spread gas dissolves in the liquid medium and/or reacts with one or more components within the liquid medium.

23-57. (canceled)

58. The system of claim 1, wherein the liquid medium comprises one or more components that are configured to react with the spread gas.
